(19) United States
(12) Patent Application Publication
(10) Pub. No.: US 2022/0309292 A1
(43) Pub. Date: Sep. 29, 2022

(54) GROWING LABELS FROM SEMI-SUPERVISED LEARNING

(71) Applicant: International Business Machines Corporation, Armonk, NY (US)

(72) Inventors: Conrad M. ALBRECHT, White Plains, NY (US); Siyuan LU, Yorktown Heights, NY (US)

(21) Appl. No.: 17/200,099

(22) Filed: Mar. 12, 2021

(51) Int. Cl. G06K 9/62; G06N 3/08

(52) U.S. Cl. CPC G06K 9/6259; G06K 9/6268; G06K 9/6202; G06K 9/6298; G06N 3/088

(57) ABSTRACT

A computer-implemented method, a computing system, and a computer program product, for automatically labeling an amount of unlabeled data for training one or more classifiers of a machine learning system. A method includes iteratively processing unlabeled data items. Receiving an unlabeled data item into each autoencoder in an autoencoder architecture. Each autoencoder processing with a lowest loss of information the unlabeled data item that is likely associated with a label associated with the autoencoder, while processing with a higher loss of information the unlabeled data item that is likely not associated with the label. Predicting, based on loss of information, a probability distribution for the unlabeled data item. Automatically associating the label to the unlabeled data item, based on the label being associated with a highest probability in a peaking probability distribution associated with the unlabeled data item. The autoencoder architecture can include a cloud computing network architecture.

### BACKGROUND

The present invention generally relates to machine learning systems that use labeled data and classifiers to classify unlabeled data. More particularly, the present invention relates to methods of automatically generating labels for unlabeled data and associating the labels with the unlabeled data thereby creating more labeled data.

A machine learning system normally benefits from increased classification accuracy by using a larger amount of accurately labeled data to train classifiers of the machine learning system. Unfortunately, it is typically not feasible to provide sufficient accurately labeled data, using manual methods to label previously unlabeled data. Using humans to create labels (e.g., human annotated text describing an aspect of the associated data item), and to associate particular labels with their respective data items thereby manually creating labeled data, is pretty time-consuming and also expensive.

There often is a very large amount of unlabeled data. However, only a small portion of this unlabeled data might be accurately classified and labeled by using manual methods. Typically an expert, e.g. a person who understands a domain of relevant classes of data, is needed to label previously unlabeled data. A great amount of manual effort, and particularly by an expert, e.g. a person who understands a domain of relevant classes of data, is typically needed to label previously unlabeled data to generate labeled data which can be used to train classifiers of a machine learning system. Unfortunately, many conventional machine learning systems suffer from using only a small amount of accurately labeled data to train classifiers of such a system. These conventional machine learning systems are either not sufficiently accurate or too costly to develop for widespread commercial deployment.

### BRIEF SUMMARY

In one example, a computer implemented method includes receiving a collection of unlabeled data, each unlabeled data item in the collection having unknown membership in any of one or more classified labeled sets of data associated with respective one or more labels in a set of labels which are associated with respective one or more classifiers in a machine learning system, each classified labeled set of data being used to train a respective each classifier associated with the each classified labeled set of data, and wherein the computing processing system comprising an autoencoder architecture including one or more autoencoders in which each autoencoder is associated with a respective one label in the set of labels; receiving at a data input device of the computing processing system a small collection of labeled data, each labeled data item in the collection being accurately assigned a particular label, with a high level of confidence, from the one or more labels in the set of labels, the accurately assigned particular label indicating that the labeled data item is a member of one of the one or more classified labeled sets of data; associating a probability distribution to each labeled data item in the collection of labeled data, the probability distribution including one probability associated with each label in the set of labels, where a probability in the probability distribution that is associated with the accurately assigned particular label being set to 1.0, and where every other probability in the probability distribution associated with the each labeled data item being set to 0.0; associating a probability distribution to each unlabeled data item in the collection of unlabeled data, the probability distribution including one probability associated with each label in the set of labels, where each probability in the probability distribution associated with the each unlabeled data item being set to the number 1.0 divided by the total number of labels in the set of labels; iteratively processing, with the autoencoder architecture, each unlabeled data item in the collection of unlabeled data by: receiving a same unlabeled data item at an input of each autoencoder in the one or more autoencoders, where each autoencoder has been trained and has learned to process each particular data item received at an input of the each autoencoder, and where each autoencoder processes most accurately, with a lowest loss of information, a particular data item that is likely associated with a label associated with the each autoencoder, while processing less accurately, with a higher loss of information, a particular data item that is likely not associated with a label associated with the each autoencoder; the autoencoder architecture, based on the loss of information determined by each autoencoder in the one or more autoencoders processing the each individual unlabeled data item, predicting a probability distribution for the each individual unlabeled data item; and the autoencoder architecture updates a probability distribution already associated with the each individual unlabeled data item with the predicted probability distribution, based on a determination that the predicted probability distribution is more peaking than the probability distribution already associated with the each individual unlabeled data item; and repeating the iteratively processing, with the autoencoder architecture, of a next unlabeled data item in the collection of unlabeled data, until a stop condition is detected by the autoencoder architecture; and in response to the autoencoder architecture detecting a stop condition, the autoencoder architecture automatically associating a label in the set of labels to at least one processed unlabeled data item, based on the label being associated with a highest probability in a peaking probability distribution associated with the at least one processed unlabeled data item in the collection of unlabeled data.

According to various embodiments, a computer-implemented method for automatically labeling an amount of unlabeled data for training one or more classifiers of a machine learning system, the method comprising: receiving a collection of unlabeled data; receiving a collection of labeled data, each labeled data item in the collection being associated with a label in a set of labels, each label being associated with a set of classified labeled data in a collection of one or more sets of classified labeled data, and each set of classified labeled data being associated with a respective classifier in a set of classifiers in a machine learning system; associating a probability distribution, including one probability value for each label in the set of labels, to each labeled data item in the collection of labeled data, the probability value associated with the label of the each labeled data item being set to a first value, and every other probability in the probability distribution being set to a second value; associating a probability distribution to each unlabeled data item in the collection of unlabeled data, each probability value in the probability distribution being set to the number one divided by a total number of labels in the set of labels; iteratively processing each unlabeled data item in the collection of unlabeled data, with an autoencoder architecture including one or more autoencoders, each autoencoder being associated with one label in the set of labels, the iteratively processing comprising: receiving a same unlabeled data item, from the collection of unlabeled data, at an input of each autoencoder in the one or more autoencoders, wherein the each autoencoder has been trained and has learned to process each particular data item received at its input, with a lowest loss of information when the each particular data item is likely associated with a label associated with the each autoencoder, and to process each particular data item received at its input, with a higher loss of information, when the each particular data item is likely not associated with a label associated with the each autoencoder; the autoencoder architecture, based on the loss of information determined by each autoencoder processing the same unlabeled data item, predicting a probability distribution for the same unlabeled data item; and the autoencoder architecture updating a probability distribution already associated with the same unlabeled data item with the predicted probability distribution, based on a determination that the predicted probability distribution is more peaking than the probability distribution already associated with the same unlabeled data item; and repeating the iteratively processing a next unlabeled data item in the collection of unlabeled data, until a stop condition is detected by the autoencoder architecture, and in response associating a label to each processed unlabeled data item associated with a peaking probability distribution.

The above computer implemented method, according to certain embodiments, can further include: in response to the autoencoder architecture detecting a stop condition, the autoencoder architecture automatically associating a label in the set of labels to at least one processed unlabeled data item, based on the label being associated with a highest probability value in a peaking probability distribution associated with the at least one processed unlabeled data item in the collection of unlabeled data.

According to various embodiments, a computing processing system and a computer program product are provided according to the computer-implemented methods provided above.

### BRIEF DESCRIPTION OF THE DRAWINGS

The accompanying figures wherein reference numerals refer to identical or functionally similar elements throughout the separate views, and which together with the detailed description below are incorporated in and form part of the specification, serve to further illustrate various embodiments and to explain various principles and advantages all in accordance with the present invention, in which:

FIG. 1 is a block diagram illustrating an example of a computer-implemented method for growing labels for unlabeled data, according to various embodiments of the invention;

FIG. 2 is a block diagram illustrating an example architecture of a computer processing system including autoencoders, according to various embodiments of the invention;

FIG. 3 is a block diagram illustrating an example computer processing system implemented as a server node in a communication network, according to various embodiments of the invention;

FIG. 4 depicts an example cloud computing environment suitable for use in various embodiments of the invention;

FIG. 5 depicts abstraction model layers according to the example cloud computing environment of FIG. 4;

FIG. 6 is a block diagram illustrating an example of a label priority history database, in accordance with various embodiments of the invention;

FIG. 7 is a block diagram illustrating an example architecture of a computer processing system including autoencoders, according to various embodiments of the invention;

FIG. 8 is a block diagram illustrating an example architecture of a computer processing system including autoencoders, according to various embodiments of the invention;

FIG. 9 is a block diagram illustrating a second example architecture of a computer processing system including autoencoders, according to various embodiments of the invention;

FIG. 10 is a block diagram illustrating an example of a computer-implemented method for growing labels for unlabeled data, according to various embodiments of the invention;

FIG. 11 illustrates an evolution of reconstruction loss for handwritten digits trained on a convolutional autoencoder;

FIG. 12 illustrates a process of conditioning an autoencoder;

FIG. 13 illustrates an evolution of a class probability determined through conditioning of autoencoders;

FIG. 14 illustrates a confusion matrix for initialized label probabilities for labeled and unlabeled data;

FIG. 15 illustrates confusion matrices similar to FIG. 14, but after system initialization which conditions the autoencoders on labeled data;

FIG. 16 illustrates an evolution of training loss for growing labels; and

FIG. 17 illustrates an evolution of relative weight of the confusion matrices separately visualized for labeled and unlabeled data.

### DETAILED DESCRIPTION

As required, detailed embodiments are disclosed herein; however, it is to be understood that the disclosed embodiments are merely examples and that the systems and methods described below can be embodied in various forms. Therefore, specific structural and functional details disclosed herein are not to be interpreted as limiting, but merely as a basis for the claims and as a representative basis for teaching one of ordinary skill in the art to variously employ the present subject matter in virtually any appropriately detailed structure and function. Further, the terms and phrases used herein are not intended to be limiting, but rather, to provide an understandable description of the concepts.

The description of the embodiments of the invention is presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to explain the principles of the invention and the practical application, and to enable others of ordinary skill in the art to understand the invention for various embodiments with various modifications as are suited to the particular use contemplated. The terminology used herein is for the purpose of describing particular embodiments only and is not intended to be limiting of the invention.

Various embodiments of the present invention are applicable in a wide variety of environments including, but not limited to, cloud computing environments and non-cloud computing environments.

In machine learning systems, supervised training is a process of optimizing a function with parameters to predict (continuous) labels from input of unlabeled data, or partially labeled data, such that the prediction is close (continuous case) or equal (discrete case) to the ground truth. In real-world scenarios, a machine learning system typically is confronted with a limited (e g, small) set of labeled data for use by classifiers of the machine learning system. This is due to a very labor-intensive process of building the associated labeled data.

Labeled data is one or more samples of a particular class of data that have been tagged with one or more labels that describe an association between a particular labeled data item and a particular class of data in which the particular labeled data item likely belongs. The activity of labeling data items typically includes selecting a particular unlabeled data item from a set of unlabeled data and associating (tagging) the particular unlabeled data item with a label (with an informative tag). A label associated with a particular data item, in certain contexts, can comprise human annotated text describing an aspect of the associated particular data item and further describing an association between the particular labeled data item and a particular class of data in a machine learning system. It should be understood that, according to certain embodiments, the term unlabeled data may also include partially labeled data where not all labels that should be associated with the particular unlabeled data item have been associated therewith in a machine learning system.

Preliminary Overview of Example Embodiments of the Invention

An association of a label with (tagged to) a particular unlabeled data item may create a particular labeled data item where the label, with a high level of confidence, describes a likely association between the particular labeled data item and a particular class of labeled data in which the particular labeled data item likely belongs. According to various embodiments, there are a finite number of classes of data and a finite number of labels respectively associated with the classes of data, e.g., one label in a finite set of labels is associated with a respective one class in a finite set of classes of data. For example, a machine learning system, for simplicity in discussion, includes three classes of data. A data label might indicate whether a satellite image contains an ocean view (class 1), or a satellite image contains a land rural view (class 2), or a satellite image contains a land city view (class 3). Other examples of data labels may include, but are not limited to: a data label indicating whether a photo image file contains a visible cow, whether a certain word or words were uttered in an audio recording file, whether a certain activity is shown being performed in a video image file, whether a certain topic is found in a news article, or whether a medical image file (e.g., an MRI, an X-ray, etc.) shows a certain medical condition.

A computer implemented method, according to various embodiments of the invention, can operate to increase a limited (e.g., a small) amount of labeled data to a much larger amount of labeled data from a large (typically massive) set of unlabeled data. Such much larger set of accurately labeled data could be used to increase the accuracy of classifier(s) in a machine learning system.

Accurately labeled data, e.g., that is associated with a high confidence level (high probability) of being a member of a particular set of classified labeled data associated with a particular classifier of a machine learning system, according to certain embodiments, can be included in the particular set of classified labeled data associated with the particular classifier. This increases an amount of accurately labeled data in a particular set of classified labeled data, which can be used to train at least a particular classifier and thereby improve the accuracy of at least the particular classifier in a machine learning system.

In the current era of Big Data a massive set of unlabeled data might be available, such as from data mining procedures. A computer-implemented method, according to various embodiments, provides a technique to automatically increase an amount of labeled data from a small amount of labeled data, and a large (typically massive) amount of unlabeled data, to a much larger amount of labeled data, as will be discussed more fully below.

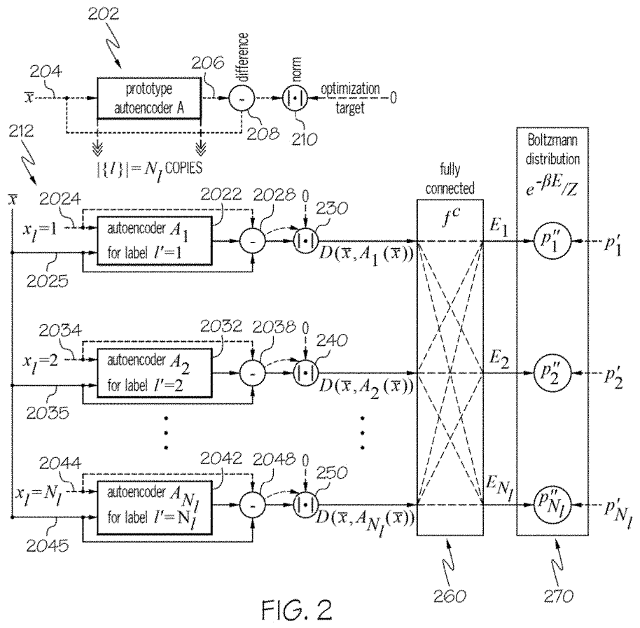

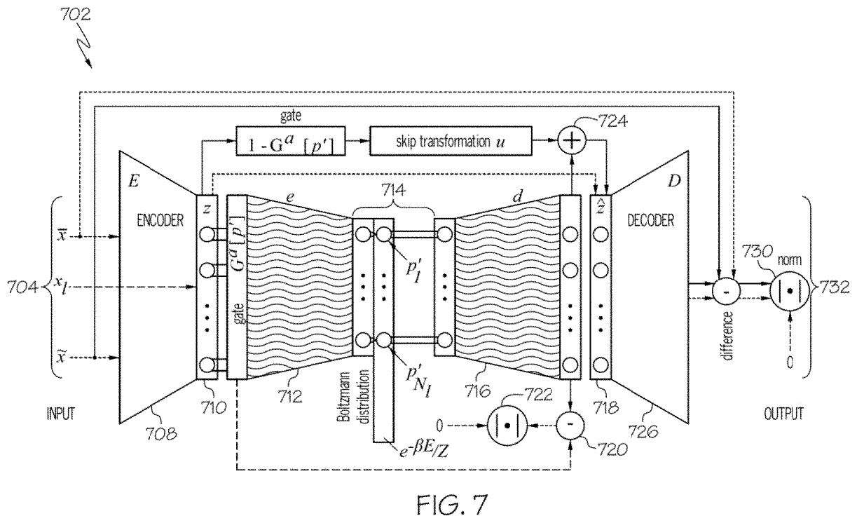

For example, a computer processing system, according to various example embodiments as discussed herein, can include at least one autoencoder artificial neural network (also referred to as “autoencoder”). Example system architectures including one or more autoencoders are shown in FIGS. 2 and 7, which will be discussed in more detail below.

An autoencoder 702, for example as shown in FIG. 7, is a type of artificial neural network used to learn efficient data codings typically in an unsupervised manner. The aim of an autoencoder is to learn a representation (encoding) for a set of data, typically for dimensionality reduction (e.g., compression), and possibly also, by training the autoencoder 702, for ignoring signal “noise” in the data.

In a very general sense, a data item X, whether labeled or unlabeled, can be received at an input 704 of an encoder side (a reduction or compression side) 708 of the autoencoder 702. A reduced or compressed version (e.g., reduced dimensions) of the data item X received at the input 704 is passed forward from the encoder side 708 to a compressed data code (z) 710 portion of the autoencoder 702. Then, the reduced version (z) of the data item is passed forward from the compressed data code (z) 710 portion of the autoencoder 702 to a decoder side (a reconstructing side) 726 which learns how to generate at an output 730, 732 of the autoencoder 702, from the reduced or compressed encoding 710, a representation as close as possible to its original input X 704. An autoencoder 702 is a neural network that learns to copy essentially its input 704 to its output 730, 732.

The autoencoder 702 has an internal (hidden) layer of networked nodes that describes a compressed data code (z) 710 used to represent the input X 704. An autoencoder is constituted by two main parts: an encoder 708 that maps the data at an input 704 into the compressed data code (z) 710, and a decoder 726 that maps the compressed data code (z) 710 to a reconstruction of the data X at the input. The decoder 726 then provides, at an output 732 of the autoencoder 702, the reconstructed version of the data X at the input. The above description is very general and simplistic, and the autoencoder architecture 702 shown in FIG. 7 will be discussed in more detail below.

The computer processing system, according to various embodiments, includes at least one autoencoder in an autoencoder architecture that can predict, by tuning parameters associated with each autoencoder, a probability of a particular known label associated with a classifiers in a machine learning system being associated to a particular unlabeled data. Given a set of labeled data, the computer processing system associates known label(s) to (a subset of) unlabeled data such that the probability of a label assigned to an unlabeled data item is equivalent to a probability in a probability distribution of the given labeled data, which will be discussed in more detail below.

Typically, instances of unlabeled data have no exact representative in a labeled data set. Further, an unknown label might exist for a particular unlabeled data that is not covered by the set of known labels associated with the labeled data. Therefore, according to various embodiments, a particular unlabeled data, at least initially, is assigned an equal probability (e.g., 1 divided by a total number of known labels) as a fraction of a total probability of 100% of being assigned each known label in the machine learning system. That is, the particular unlabeled data initially could be equally likely to be assigned any individual known label from a set of known labels in the machine learning system. Each known label is associated with a set of classified labeled data (a class of labeled data) which is associated with a classifier in the machine learning system. Therefore, the particular unlabeled data, at least initially, is assigned a probability (e.g., 1 divided by a total number of sets of labeled data) as a fraction of a total probability of 100%, of being equally likely a member of any one of the sets of classified labeled data in the machine learning system.

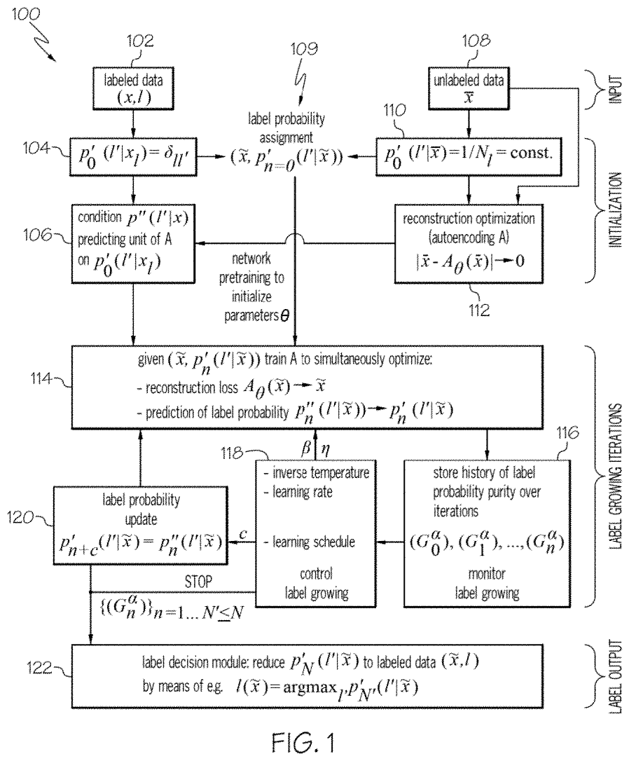

As initial steps in an example computer implemented method 100, such as illustrated in FIG. 1, each of the labeled data and unlabeled data are assigned 102, 104, 108, 109, 110, a probability of being a member of each set of one or more sets of classified labeled data, e.g., each set being associated with a known classified label which is associated with a classifier in a set of classifiers in the machine learning system. The total probability of an unlabeled data item under examination being a member of any one of the sets of classified labeled data is normally 100 percent. This probability can also be expressed as the number 1.0. The total probability is equal to the sum of all of the individual probabilities of the unlabeled data item under examination being a member of each of the sets of classified labeled data.

If a data item is a labeled data with a high level of confidence (a high probability) that it was accurately labeled, then the probability of that data item being a member of a particular one of the sets of classified labeled data is assigned as 100 percent, and all of the other individual probabilities of the data item being a member of another one of the sets of classified labeled data will be assigned zero percent. This zero percent probability can also be expressed as the number 0.0.

The initial probability of an unlabeled data item under examination being a member of any one of the sets of classified labeled data, would be normally 100 percent divided by the total number of sets of classified labeled data (e.g., divided by the total number of labels). For example, if there are three sets of classified labeled data (e.g., three labels that in this example respectively represent either: a satellite image that contains an ocean view, or a satellite image that contains a land rural view, or a satellite image that contains a land city view) then the probability of an unlabeled data item being a member of any one of the three classes (the three sets of classified labeled data) would be 33⅓ percent associated with the unlabeled data item for each of the three sets of classified labeled data. That is, and unlabeled data item initially would be assigned 33⅓% probability that it is a member of any one of the three sets of classified labeled data. The unlabeled data item (which has unknown membership in any of the three sets of classified labeled data in this example), initially is assigned the three probabilities (33⅓%, 33⅓%, and 33⅓%) associated with the three respective sets of classified labeled data, where the sum of the three probabilities totals 100%.

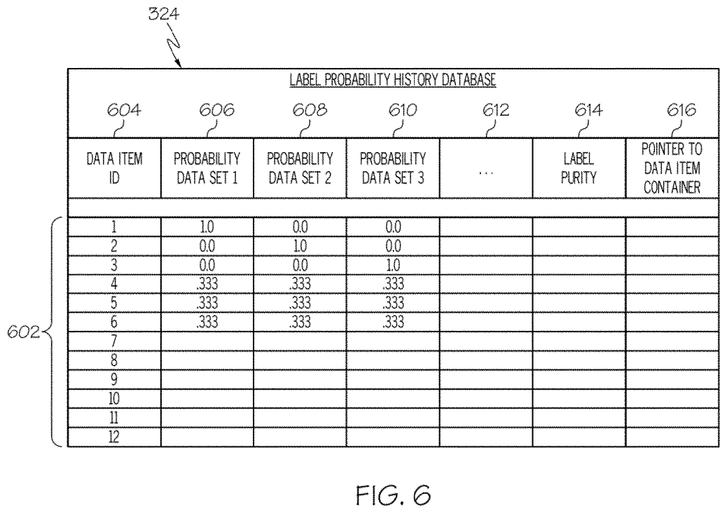

Continuing with the example discussed above, each data item, whether it is labeled or unlabeled data, is represented in an example computer processing system by a set of probabilities related to the respective set of labels associated with the respective set of classified labeled data, and which is associated with the respective set of classifiers, in a machine learning system. According to the example discussed above, with reference to FIGS. 1, 3, and 6, an example computer implemented method 100, performed by an example computer processing system 300, tracks three probabilities associated with each data item, whether labeled data or unlabeled data. The history of probabilities associated with each data item is tracked, according to this example, in a label probability history database 324. As illustrated in FIG. 6, an example label probability history database 324 contains individual records 602 for data items being processed by the computer processing system 300.

Each of the data item records 602 includes a data item record identifier 604, and a plurality of probabilities respectively associated with each of the labels in the machine learning system. As discussed above, each of the labels is associated with a respective classified labeled data set in a plurality of classified labeled data sets which is associated with a respective classifier in a plurality of classifiers, in a machine learning system. With respect to an initialization phase 102, 104, 108, 109, 110, of the example computer implemented method 100 performed by the computer processing system 300, each data item being processed is either labeled data 102 or unlabeled data 108.

For labeled data, where the label has been assigned to the particular data item, with a high confidence level (high probability) that the label accurately describes the particular data item as being a member of one of the classified labeled data sets, the probability of the particular data item being a member of a particular classified labeled data set is assigned 100% (also referred to as 1.0), while the probabilities of the particular data item being a member of any of the other classified labeled data sets are each assigned 0% (also referred to as 0.0).

For example, each of the data item records 602 with data item record ID's 1, 2, and 3, (associated with labeled data) is initially assigned a probability of 1.0 for one of the three classified labeled data sets 606, 608, 610, which is associated with the particular label of the particular data item. The other probabilities (other than the probability of 1.0 of the classified labeled data set associated with the particular label of the particular data item) in each data item record 602 for data item record IDs 1, 2, and 3, are initially assigned a probability of 0.0.

For unlabeled data, continuing with the above example, data item records 602 with data item record ID's 4, 5, and 6, are associated with unlabeled data. Each such data item has not been assigned a known label in the machine learning system. Each such data item has unknown membership in any of the three classified labeled data sets 606, 608, 610. Accordingly, each of the respective data item records 602, with data item record ID's 4, 5, and 6, is initially assigned a probability of 0.333 (1.0 divided by 3, which is the total number of known labels in the machine learning system). As shown in FIG. 6, in various embodiments each record 602 can also include additional probabilities 612 for additional labels, and respectively associated classified labeled data sets, in a machine learning system.

An example computer implemented method, such as shown in FIG. 1, comprises an initialization phase, which includes initialization, conditioning, and specialization of autoencoders 336 in a computer processing system 300. After the initialization input phase, the example computer implemented method 100, according to various embodiments, will update probabilities distribution (e.g., three probabilities for three labels in a machine learning system), associated with each individual data item being processed by the computer processing system 300 and the autoencoder architecture 212 in a label growing iterations phase, as will be discussed below. Lastly, according to the example, a label decision is made 122 and a label may be assigned to a particular individual data item in a label output phase of the example computer implemented method 100.

According to the example, a label purity measure (which according to various examples can be a collection of a historical set of label purity measures) 614 will also be associated with each data item record 602. The label purity measure(s) 614, as will be discussed more fully below, is/are used by various embodiments of the invention to keep track of progress in changes in probability value assignments to a probability distribution associated with each particular data item. The probability distribution associated with each data item corresponds to a set of probabilities tracked in each data item record 602 which is associated with the particular data item. These label purity measures associated with the data item records 602 can be used to monitor or track label probability classification purity for each data item being iteratively processed by the computer implemented method 100, as will be discussed more fully below.

Continuing with the above example, one or more pointers 616 are associated with the each data item record 602. The one or more pointer(s) point(s) to container(s) (or location(s) in main memory, or in storage, or both) where a data item (and possibly a compressed version and an expanded version of the data item) is/are stored or located. The pointer(s) can be used by the computer implemented method 100 as a mechanism to access the particular data item and possibly also to access the compressed version and the expanded version of the particular data item, as will be discussed in more detail below. A more detailed discussion of the example computer implemented method 100 will be provided below.

One objective of the example computer implemented method 100 is to iteratively update the probabilities in the probability distribution associated with a particular data item, based on optimizing a reconstruction error associated with an autoencoder processing the particular data item. According to the example, one autoencoder is associated with a respective each label in a set of labels, which is associated with a respective one classifier in a set of classifiers, which is associated with a set of classified labeled data used to train the respective one classifier in the set of classifiers. An example computer processing system 300 that is processing data items with three classes of data items (e.g., with three labels, three respective classifiers, and three respective sets of classified labeled data items) would use, according to the example, three autoencoders in an architecture. However, another number of autoencoders might be used according to various embodiments of the invention.

An autoencoder is typically a neural network structure, or another computer processing structure. According to various embodiments, an autoencoder architecture may include a cloud computing network architecture and/or a high performance computing network architecture.

An autoencoder can receive at an input of the autoencoder a data item which then the autoencoder processes the data item (e.g., a transformation of the data item occurs in the autoencoder). In response to processing the data item the autoencoder provides at an output a reconstructed version of the data item which was received as input.

For example, with respect to data items that represent images, an input image might be processed by aggregating some pixels in the image, and multiply them by values, and the transformed image gets smaller and smaller (e.g., compression of the image) to a compressed encoded version of the image. The autoencoder then takes the compressed encoded version of the image and up-scales it (expands and decodes it) and thereby provides at an output of the autoencoder a reconstructed version of the image which was received at an input of the autoencoder.

Ideally, a reconstructed version of the image at the output exactly matches the input image. By iteratively tweaking and adjusting parameters in the autoencoder, the autoencoder can provide a reconstructed version of the image at the output that exactly matches (or that substantially matches within an acceptable tolerance deviation) the input image. In this way, the autoencoder (and its performance at processing input images) can be optimized. That is, the autoencoder learns a meaningful representation of the input image. Typically, the input image passes through a bottleneck in the autoencoder where the autoencoder generates a compressed encoded version of the image. From that compressed encoded version the autoencoder then expands and reconstructs an image which the autoencoder provides at an output of the autoencoder. Ideally, the output image matches (or substantially matches within an acceptable tolerance deviation) the input image.

As part of processing an input image, the autoencoder tweaks and adjusts internal parameters (internal to the autoencoder) that affect the encoding/compression of the input image to generate the compressed encoded version of the image. The autoencoder also tweaks and adjusts internal parameters (internal to the autoencoder) that affect the decoding/expansion from the compressed encoded version of the image to a reconstructed version of the input image at an output of the autoencoder. This adjustment process can be done iteratively by the autoencoder to tweak and adjust the internal parameters (internal to the autoencoder) until the input image and the output image match (or substantially match within an acceptable tolerance deviation) each other.

An autoencoder does not require labeled data items as inputs to enable learning by the autoencoder. That is, an autoencoder processes an input data item based on a probability distribution associated with the data item, and does not need to know any label associated with the data item. In the example, each data item can be received at an input into all three autoencoders in the computer processing system, with reference to the set of three probabilities associated with the each data item, regardless of whether the data item was labeled data or unlabeled data. The three autoencoders do not need to know any label associated with a data item to learn from processing the data item and associating probabilities to the data item, as will be discussed more fully below. After the initial assignment of a set of three probabilities to each data item, as discussed in the example above, a computer implemented method 100 iteratively tweaks and adjusts parameters within each of the three autoencoders while iteratively processing the each data item in the computer processing system 300. Also, as part of the processing, the autoencoder architecture also iteratively updates the probabilities in a probability distribution assigned to the each data item, as will be more fully discussed below.

As illustrated in the example of FIG. 2, each of the three autoencoders 2022, 2032, 2042, is initialized, conditioned, and trained, which will be discussed in more detail below. The training of each autoencoder 2022, 2032, 2042, specializes or refines the each autoencoder performance processing input data items, with respect to one set of classified labeled data associated with the each autoencoder. The training causes each autoencoder to iteratively tweak and adjust parameters associated with the each autoencoder, according to its associated set of classified labeled data.

In general, while processing an unlabeled data item each autoencoder is accordingly trained (which may also be referred to as specialized or refined) to process as accurately (lowest loss of information) as possible the unlabeled data item received at its input 2025, 2035, 2045. The each autoencoder and the autoencoder architecture, in response to processing the unlabeled data item, also update a respective probability in a probability distribution associated with the data item. The autoencoder architecture can update the respective probability in a peaking probability distribution to a highest probability value in the probability distribution (e.g., a highest probability value up to a maximum probability value of 1.0), while the other probabilities in the probability distribution are much lower values than the highest probability value, indicating the unlabeled data item being processed (under examination) by the each autoencoder is more likely (predicted to be) a member of the set of classified labeled data associated with the each autoencoder (associated with the highest probability value). The other two autoencoders process poorly the same unlabeled data item and the autoencoder architecture typically updates the respective probabilities in a probability distribution to a much lower probability value that can range down to a minimum probability value approaching 0.0), indicating that the unlabeled data item is less likely (predicted to not be) a member of those other two sets of classified labeled data respectively associated with the other two autoencoders.

After each of the three autoencoders 2022, 2032, 2042, is initialized, conditioned, and trained, a same unlabeled data item is received as input 2025, 2035, 2045, into each of the three autoencoders 2022, 2032, 2042. Each autoencoder processes the same unlabeled data item received as input, e.g., by encoding (compressing) the data item to a compressed (encoded) version of the data item and then decoding (reconstructing or expanding) the compressed version of the data item to provide at an output of the autoencoder a reconstructed version of the data item.

An unlabeled data item that is processed most accurately (closest to zero loss of information after the processing of the unlabeled data item) by one of the three autoencoders 2022, 2032, 2042, as compared to the processing of the same unlabeled data item by the other two autoencoders, indicates that the unlabeled data item is predicted to be more likely (e.g., highest probability value in a peaking probability distribution a member of the respective set of classified labeled data associated with the one autoencoder. The highest probability value can range up to a maximum probability value of 1.0.

The same unlabeled data item would be processed poorly by the other two autoencoders in this example. The respective probability values would indicate that the unlabeled data item is predicted to be less likely (with a much lower probability value, e.g., ranging toward a minimum probability value of 0.0) a member of the respective sets of classified labeled data associated with the other two autoencoders.

With reference to FIG. 2, a more detailed description of the processing of unlabeled data items will be discussed. A same unlabeled data item is received as input 2025, 2035, 2045, into each autoencoder 2022, 2032, 2042. Each autoencoder encodes the unlabeled data item received as input 2025, 2035, 2045, and compresses the received data item to a compressed (encoded) version of the data item. Then, each autoencoder decodes (expands) the compressed version of the data item according to certain parameters of the each autoencoder, and then provides a decoded version (reconstructed version) of the data item as an output of the each autoencoder. Then, each autoencoder compares 2028, 2038, 2048, the decoded version (reconstructed version) of the data item at the encoder's output with the original data item received at the input 2025, 2035, 2045, to the particular autoencoder.

The result of the comparison (e.g., subtracting the original input data item from its reconstructed version) is then compared 230, 240, 250, to zero to determine a loss of information in the decoded version (reconstructed version) of the data item as compared 2028, 2038, 2048, to the original data item received as input 2025, 2035, 2045. The comparison 2028, 2038, 2048, results in an indication of a loss of information value. The autoencoder then compares 230, 240, 250, this loss of information value result to zero to determine how close the loss of information value is to zero loss of information. The closer it is to zero loss of information the better the particular autoencoder is in reconstructing a previously compressed encoded (code) version of the original data item received as input 2025, 2035, 2045, to the particular autoencoder 2022, 2032, 2042.

Based on this comparison 2028, 2038, 2048, and a determination 230, 240, 250, of closeness to zero loss of information, each particular autoencoder 2022, 2032, 2042, computes a probability representing a confidence level of the data item being a member of a classified labeled data set associated with the particular autoencoder 2022, 2032, 2042. The probability would also represent a confidence level of how likely it is that the data item, processed by the autoencoder, would be associated with a particular label in a machine learning system. It is understood that the particular label is also associated with a respective classifier and with a respective classified labeled data set in the machine learning system.

The computer processing system 300, with the three autoencoders 2022, 2032, 2042, processes a particular data item and computes three probabilities from the three respective autoencoders, as described above. All three probabilities are then associated with the particular data item, in this example using a data item record 602 in the label probability history database 324. Each processed data item, whether labeled data or unlabeled data, is represented by the three probabilities of being a member of each of the respective three sets of classified labeled data and accordingly three labels (e.g., first, a satellite image that contains an ocean view, or second, a satellite image that contains a land rural view, or third, a satellite image that contains a land city view) classified in the machine learning system.

To be perfectly clear about the machine learning system being discussed here, according to various embodiments, each particular classifier, in a set of classifiers of the machine learning system, is associated with a particular set of classified labeled data. Each particular set of classified labeled data is used to train a respective particular classifier so that the particular classifier can analyze an unlabeled data item and determine whether the unlabeled data item is a member of one of one or more sets of classified labeled data. Accordingly, each particular classifier is associated with a particular label which is associated with a particular set of classified labeled data in a machine learning system.

The example computer implemented method 100, according to various embodiments, operates with an example computer processing system 300 by tweaking and adjusting a set of probabilities associated with each processed data item, whether labeled or unlabeled data, by iteratively tweaking and adjusting parameters associated with each autoencoder in a set of autoencoders (e.g., in a set of three auto encoders).

Each autoencoder is defined by a set of specific rules and a set of specific parameters, which are associated with the each autoencoder. Each autoencoder is associated with a set of classified labeled data which is associated with a classifier and with a label in a machine learning system. Each autoencoder uses the set of specific rules and the set of specific parameters to encode (compress) and then decode (decompress or reconstruct) a data item received at an input of the autoencoder. A reconstructed version of the data item received at the input of the autoencoder is then provided at an output of the autoencoder. The reconstructed version of the data item, at the output of the autoencoder, can be compared to the original data item received at the input of the autoencoder, to determine a probability of how likely it is that the original data item received at the input of the autoencoder is a member of a set of classified labeled data associated with the autoencoder. This computer implemented method will be discussed in more detail below.

The example computer implemented method iteratively tweaks and adjusts the set of specific rules and the set of specific parameters associated with each of the set of autoencoders (e.g., three autoencoders), while iteratively processing data items, in an attempt to correctly converge a set of probabilities associated with the each particular data item being processed. This convergence of probabilities can be used to indicate a probability of likelihood of membership of the each particular data item in a particular set of classified labeled data out of all the sets of classified label data in a machine learning system. This convergence of probabilities associated with the each particular data item can be used to indicate a probability of likelihood of correctly assigning a label in a set of labels, to the each particular data item according to the label probability distribution (e.g., three label probabilities) associated with the particular data item.

Finally, based on the converged set of probabilities, a label assignment controller 342, 122, in the example computer processing system 300, can compare 118, 122, 270, the set of probabilities associated with a particular data item and determine a highest probability value (e.g., closest to 1.0) therein to assign a most likely correct label to the particular data item which also indicates a likeliest corresponding membership in a particular set of classified labeled data. The label assignment controller 122, 342, 270, accordingly, assigns the most likely correct label to the particular data item being processed.

Based on the converged set of probabilities indicating that the assigned label to the particular data item correctly indicates, with a high level of confidence, a corresponding membership in a particular set of classified labeled data. The label assigned to the particular data item also creates an instance of correctly classified labeled data. According to various embodiments, this instance of correctly classified labeled data, with a particular label correctly assigned to a particular data item, can then be included in the corresponding set of classified labeled data. The inclusion of the correctly classified labeled data then increases the number of members in the corresponding set of classified labeled data. Thereby, the larger set of classified labeled data can be used to train a classifier associated therewith, which will likely improve the accuracy of classification by the classifier in a machine learning system.

A high level of confidence, for example, can be a high probability threshold value that is a configured parameter 334 in the computer processing system 300. For example, and not for limitation, a high probability threshold value could be set as a configuration parameter 334 to 75%. Alternatively, the high probability threshold value could be set to 90%, or it could be set to 95%, etc. Based on the converged set of probabilities 270 (probability distribution) associated with a particular data item indicating a highest probability value in the set which is above the configured high probability threshold value, it would indicate, with a high level of confidence, that the particular data item is a member of a particular set of classified labeled data. That is, the particular data item is correctly and reliably associated with a particular label associated with a particular set of classified labeled data. With a high level of confidence, according to various embodiments, this particular data item automatically associated with the particular label can be considered an instance of correctly classified labeled data. Accordingly, the instance of correctly classified labeled data can be included in a corresponding set of classified labeled data associated with the particular label, which can be used to train a particular classifier associated with the particular label and likely improve the classifier's classification accuracy.

In summary, according to an example computer processing system 300, a set of autoencoders 2022, 2032, 2042, in the computer processing system 300 can process the initial set of data items, each being associated with a set of probabilities as described above, to iteratively tweak and adjust parameters associated with each of the autoencoders 2022, 2032, 2042, to optimize reconstruction 338, 118, of the data items and to tweak and adjust 120 individual probabilities in a distribution of probabilities 606, 608, 610, 612, associated with each particular data item (e.g., represented by a data item record 602 in a label probability history database 324) to correctly converge the probabilities to a set of probabilities that indicates a probability of the particular data item's likely membership in a set of classified labeled data associated with a classifier of the machine learning system. More details of various embodiments of the computer implemented method and further examples will be discussed below.

Example System Architecture Including Autoencoders in Various Embodiments

FIG. 2 shows an example of a computer processing system which includes several autoencoders, as will be discussed below.

A computer network architecture including one or more autoencoders (which may also be referred to as an autoencoder architecture) 212 can be used to predict a label probability distribution associated with each data item processed by the autoencoder architecture 212, given with proper pre-training (initialization and conditioning) of a prototype autoencoder 202. The pre-training of a particular prototype autoencoder 202 can be done by first initializing (configuring) it to a predetermined configuration of parameters and rules associated with the particular prototype autoencoder 202, and then conditioning (optimizing) the initialized particular prototype autoencoder 202. The conditioning (optimizing) can be done by a reconstruction optimizer controller 338.

The reconstruction optimizer controller 338, 112, conditions (optimizes) the initialized particular prototype autoencoder 202 by causing it to process a large batch of data items, including labeled data and unlabeled data, that are received at its input 204. The output 206 of the particular prototype autoencoder 202 provides a reconstructed version of the original data item received at its input 204. The reconstructed version of the original data item at the output 206 is compared 208 to the original data item received at the input 204, and the result of the comparison indicates a loss of information value. This loss of information value is then compared 210 to a target zero loss of information.

The particular prototype autoencoder 202 has configuration parameters and rules that are iteratively tweaked and adjusted by the reconstruction optimizer controller 338, 112, while causing the particular prototype autoencoder 202 to iteratively process the large batch of data items, including both labeled and unlabeled data. The reconstruction optimizer controller 338, 112, thereby conditions (optimizes) the particular prototype autoencoder 202.

The calculated loss of information 208 of each individual data item, being processed by the particular prototype autoencoder 202, is compared 210 to an optimization targeting zero loss of information. A goal of the iterative adjustment of the configuration parameters and rules over the large batch of data items is to optimize the performance of the particular prototype autoencoder 202 to an optimum level of loss of information value while iteratively processing individual data items from the large batch of data items including both labeled and unlabeled data. That is, the particular prototype autoencoder 202 reconstructs, as accurate as possible, any input data item 204 in the large batch of input data items. The configuration parameters and rules in the particular prototype autoencoder 202 are iteratively tweaked and adjusted by the reconstruction optimizer controller 338, 112, while causing the particular prototype autoencoder 202 to iteratively process the large batch of data items. In the current example, the particular prototype autoencoder 202 reconstructs, as accurate as possible, any image in a large batch of images which can include any of a satellite image that contains an ocean view, or a satellite image that contains a land rural view, or a satellite image that contains a land city view.

After the particular prototype autoencoder 202 is initialized and conditioned (optimized), the particular prototype autoencoder 202 is then copied into the autoencoder architecture 212 to become each particular autoencoder of the set of autoencoders 2022, 2032, 2042, in the autoencoder architecture 212. In our example, the particular prototype autoencoder 202 would be copied three times (three autoencoders 2022, 2032, 2042), one copy of the particular prototype autoencoder for each class and associated label in the machine learning system.

Each particular prototype autoencoder 2022, 2032, 2042, that has been initialized and optimized, as discussed above, is then trained (which may also be referred to as specialized or refined) by the reconstruction optimizer controller 338, 112, 106, by providing at an input 2024, 2034, 2044, of each particular autoencoder 2022, 2032, 2042, individual classified labeled data items from a particular set of classified labeled data associated with one label from a set of labels in a machine learning system. The particular autoencoder 2022, 2032, 2042, is thereby trained by iteratively processing each individual classified labeled data item from the particular set of classified labeled data. The processing of each individual classified labeled data item typically includes encoding (compressing) and then decoding (reconstructing) the each individual classified labeled data item and then providing a reconstructed version of the individual classified labeled data item at an output of the particular autoencoder 2022, 2032, 2042.

The reconstructed version at the output is then compared 2028, 2038, 2048, with the individual classified labeled data item received at the input 2024, 2034, 2044. A result of the comparison 2028, 2038, 2048, indicates a loss of information value. This loss of information value is then compared 230, 240, 250, to a target zero loss of information.

Based on the comparison to the target zero loss of information, the reconstruction optimizer controller 338, 112, 106, iteratively tweaks and adjusts configuration parameters and rules in each particular autoencoder 2022, 2032, 2042, while iteratively processing the individual classified labeled data items from the particular set of classified labeled data to thereby train (specialize and/or refine) the accuracy of the particular autoencoder 2022, 2032, 2042, with respect to the particular set of classified labeled data. That is, this training the reconstruction optimizer controller 338, 112, 106, comprises refining the accuracy of the particular autoencoder 2022, 2032, 2042, specifically with respect to that particular class of data and its associated label. The goal of the iterative adjustment of the configuration parameters and rules over the individual classified labeled data items from the particular set of classified labeled data is to train (specialize and/or refine) the performance of the particular autoencoder 2022, 2032, 2042, to process most accurate (closest to zero loss of information) data items that are likely members of the particular set of classified labeled data associated with the trained (specialized and/or refined) particular autoencoder 2022, 2032, 2042. The above discussed initialization, conditioning (optimization), and then training (specialization) process is indicated in the example computer implemented method of FIG. 1, by the initialization, conditioning (optimization), and then training (specialization), steps 102, 104, 106, 108, 109, 110, 112. Then, the autoencoder architecture 112 is ready to start processing unlabeled data items (e.g., unknown data items) received at the inputs 2025, 2035, 2045, of the respective autoencoders 2022, 2032, 2042, and assign and update a label probability distribution associated with each unlabeled data item processed by the three autoencoders in this example.

Arrows in FIG. 2 indicate the forward pass of data in the order: Densely dotted for unlabeled initialization, narrow dashed for labeled pre-training, and solid for joint, iterative training to grow labels. The dash-dotted arrows denote training targets. The Boltzmann distribution block 270 implements the label probability distribution for each processed data item, whether labeled data or unlabeled data.

The computer network architecture (autoencoder architecture) 212 can be used to predict the label probability distribution on all data items, whether labeled data or unlabeled data, given the above discussed proper pre-training and specialization of the each autoencoder 2022, 2032, 2042. The set of trained autoencoders 2022, 2032, 2042, can discriminate and predict probability for each received labeled data item or unlabeled data item to be associated with a predicted label from a group of labels in a machine learning system.

More specifically, when an unlabeled data item is received at the inputs 2025, 2035, 2045, then the same unlabeled data item is processed by all three autoencoders 2022, 2032, 2042, in this example. The reconstruction of the unlabeled data item will typically be most accurate (closest to zero loss of information) and with a corresponding peaking probability (highest probability, toward a probability of 1.0) by one autoencoder from all three autoencoders, when the predicted label for the unlabeled data item coincides with the known label associated with the one autoencoder. The reconstruction of the same unlabeled data item will be poor (much higher loss of information, e.g., further away from zero loss of information) and a corresponding probability of a predicted label for the unlabeled data item will be a lower probability (closer toward 0.0) by processing with the other two autoencoders in this example.

A probability distribution (in this example consisting of three probabilities for the three classes) that was assigned to each particular data item at the input 2025, 2035, 2045, of the autoencoder architecture 212, whether the particular data item is labeled data or unlabeled data, can be tweaked and adjusted by the reconstruction optimizer controller 338, 112, 106, 120, operating with the autoencoder architecture 212, and a new probability distribution can be predicted 118, 260, 270, (e.g., using the Shannon entropy or cross-entropy measure) from all of the reconstructions of the autoencoders 2022, 2032, 2042. The new predicted probability distribution for the particular data item being processed, in the example, can be updated 118, 120, 270, 332, into its respective data item record 602, 606, 608, 610, 612, in the label probability history database 324. The new predicted probability distribution, for example, is compared 270 to the already existing probability distribution 602, 606, 608, 610, 612, associated with the particular data item. Then, based on the comparison, an update 118, 120, 270, 332, of the already existing probability distribution may be done by the label purity/growth controller 332, according to the example.

It should be noted that, according to various embodiment, the above example autoencoder architecture 212 and the associated example computer implemented method 100, after an iteration of processing of a particular data item may predict, and be able to adjust (update), the three probabilities in a probability distribution associated with the particular data item to a flatter (less peaking) predicted probability distribution as compared to the probability values in the already existing probability distribution of the particular data item. This adjustment (update) may be based on the comparisons of the output reconstructed version of a particular data item for each autoencoder of the three autoencoders 2022, 2032, 2042, which are each compared to the input particular data item for all three autoencoders. These comparisons can be analyzed by the autoencoder architecture 212, 260, 270, to determine the relative loss of information between the three autoencoders 2022, 2032, 2042. Three new predicted (e.g., using a Shannon entropy or cross-entropy measure) 270 probabilities are generated 270 for a predicted probability distribution to be associated with the particular data item.

A label purity/growth controller 332, 118, 270, according to the example, operates in the autoencoder architecture 212 and compares 270 the three new predicted probabilities with the already existing three probabilities associated with the particular data item. The label purity/growth controller 332, 118, then determines whether to update 120 the three probabilities in the already existing probability distribution associated with the particular data item, with the three new predicted probabilities in a predicted probability distribution for the particular data item.

Recall that a probability distribution of a labeled data item, which is known with a high level of confidence, initially is set to a probability of 1.0 for an autoencoder associated with the particular label of the labeled data item, and the other two probabilities are set to a probability of 0.0 in the example. Recall also that a probability distribution of an unlabeled data item (unknown data) initially is set to 33⅓% probabilities for all three probabilities of the particular data item in the example.

In view of the discussion above, and according to various embodiments, the label purity/growth controller 332, 118, 270, according to the example, determines which three probabilities should be in the probability distribution associated with the particular data item. If the newly predicted three probabilities improve (or substantially maintain) a peaking probability distribution that indicates, with a high level of confidence, which of the three labels is most likely (with the highest probability value in the peaking probability distribution) associated with the particular data item, then the label purity/growth controller 332, 118, 270, updates 120 the three probabilities in the already existing probability distribution associated with the particular data item with the new predicted three probabilities.

On the other hand, according to the example, if the new predicted three probabilities indicate a degradation (flattening) of a previously peaking probability distribution already associated with the particular data item, then the label purity/growth controller 332, 118, 120, 270, may decide 120 to keep the already existing peaking probability distribution associated with the particular data item, and not to update the already existing probability distribution with the new predicted three probabilities. A degradation (flattening) of a previously peaking probability distribution reduces the peaking (flattens the already existing probability distribution, which indicates with a lower level of confidence which of the three labels is most likely associated with the particular data item). Typically the flattening of the already existing probability distribution results in a flatter probability distribution (e.g., which is less indicative of which of the three labels is most likely associated with the particular data item).

So, for example, a labeled particular data item may have been initialized with a probability distribution that includes three probabilities, e.g., 1.0, 0.0, 0.0. Then, after processing the particular data item by the autoencoder architecture 212, 270, the three predicted probabilities may be closer to a flatter probability distribution that includes three probabilities that are closer to the flattest probability distribution, e.g., 0.33, 0.33, 0.33. Therefore, the label purity/growth controller 332, 118, 120, 270, may decide to keep the previously peaking probability distribution, e.g., 1.0, 0.0, 0.0, already associated with the particular data item, and not to update the already existing probability distribution with the new predicted three probabilities that are a flatter probability distribution, e.g., closer to a flattest probability distribution, e.g., 0.33, 0.33, 0.33.

According to certain embodiments, after the label purity/growth controller 332, 118, 120, 270, decides to keep the already existing probability distribution associated with the particular data item, and not to update the already existing probability distribution with the new predicted three probabilities, the reconstruction optimizer controller 338 operating with the particular autoencoder may iteratively adjust its internal parameters and rules, essentially retraining the particular autoencoder, by processing a batch of its associated classified labeled data that were assigned a label with a high level of confidence of being correct and accurate. The retraining of the particular autoencoder, and the iterative adjusting of the internal parameters and rules, may increase the level of quality (e.g., accuracy and correctness) of processing unlabeled data items by the particular autoencoder. Additionally, a new predicted set of probabilities may be iteratively adjusted 260, 270, in response to the retraining of the particular autoencoder, and may be adjusted to be a more peaking predicted probability distribution as compared to the previously predicted three probabilities. This new predicted probability distribution, in response to the retraining of particular autoencoder(s), may improve the peaking of probabilities as compared to the already existing probability distribution associated with the particular data item.

Other mechanisms for the autoencoder architecture 212 processing input data items and determining whether to update a probability distribution are possible, according to various embodiments of the invention. For example, a label associated with a labeled data item may not be known with a high level of confidence. For example, a human may have been tired and error-prone while manually applying a label to the labeled data item, and the human may have made a mistake and mislabeled the labeled data item. If the autoencoder architecture 212 is configured to automatically adjust parameters and update probabilities of a probability distribution associated with the particular labeled data item, e.g., taking into account the possibility of the above scenario where the label of the labeled data item was not assigned with a high level of confidence, the autoencoder architecture 212 may be allowed to automatically update the probabilities in a previously peaking probability distribution, even if the previously peaking probability distribution, e.g., 1.0, 0.0, 0.0, is being apparently degraded (made flatter) by the current processing and updating of the autoencoder architecture 212. That is, the probability distribution in the current iteration of processing the particular data item may be allowed to become flatter, e.g., closer to the flattest probability distribution, e.g., 0.33, 0.33, 0.33, instead of the previously peaking probability distribution, e.g., 1.0, 0.0, 0.0. The autoencoder architecture 212 in the system 300 may continue iteratively automatically processing the particular labeled data item and updating probabilities in a probability distribution associated with the particular labeled data to possibly uncover that a correct and accurate label, based on the automatic processing of the particular labeled data item by the autoencoder architecture 212, is another label different from the label that was previously manually incorrectly applied to the labeled data item.

As another example mechanism, an autoencoder architecture 212 may process 114, 118, input data items and automatically update 120 the probabilities in an already existing probability distribution associated with a particular data item, even if the current update of probabilities appears to degrade (make flatter) the previous probability distribution associated with the particular data item. The current processing of the particular data item by each particular autoencoder 2022, 2032, 2042, may cause adjustments of parameters and rules associated with the each particular autoencoder 2022, 2032, 2042. Such iterative processing of data items by the autoencoder 2022, 2032, 2042, over time may reduce the level of quality (e.g., accuracy and correctness) of processing data items by the autoencoder.

Various embodiments of the invention can counteract such a possible reduction of a level of quality (e.g., accuracy and correctness) in processing unlabeled data items over time. Various embodiments can continuously maintain a high level of quality (e.g., accuracy and correctness) of processing unlabeled data items by each autoencoder. A high level of quality, as discussed above, may be equivalent to a level of quality (e.g., accuracy and correctness) of processing unlabeled data items by a particular autoencoder, just after the particular autoencoder completes an initialization phase 102, 104, 106, 108, 109, 110, 112, as discussed above.

A reconstruction optimizer controller 338 operating with the each autoencoder 2022, 2032, 2042, in the autoencoder architecture 212 may perform, at certain times, a retraining process of each autoencoder 2022, 2032, 2042. Specifically, a batch of classified labeled data associated with a particular autoencoder 2022, 2032, 2042, can be provided at a respective input 2024, 2034, 2044, of the particular autoencoder 2022, 2032, 2042. In response, the reconstruction optimizer controller 338 operating with the particular autoencoder adjusts its internal parameters and rules essentially retraining the particular autoencoder by processing the batch of its associated classified labeled data that were assigned a label with a high level of confidence of being correct and accurate.

A high level of confidence, according to various embodiments, can be represented by a high probability (a value at or near 1.0) that the label accurately describes the particular data item as being a member of one of the classified labeled data sets. Optionally, according to certain embodiments, a high level of confidence can be represented, for example, by a peaking probability distribution with a highest probability value exceeding a high probability threshold value that is a configured parameter 334 in the computer processing system 300. For example, and not for limitation, a high probability threshold value could be set as a configuration parameter 334 to 75%. Alternatively, the high probability threshold value could be set to 90%, or it could be set to 95%, etc.

The retraining process of each autoencoder can be performed by the reconstruction optimizer controller 338 operating with the each autoencoder at certain times, such as, but not limited to, after processing each unlabeled data item, or optionally after processing a predetermined number of unlabeled data items, at a number of iterations of processing by the each autoencoder, or at other certain times based on occurrence of predetermined events and/or conditions related to the autoencoder architecture 212. For example, at certain time(s) of the day or night, or after operations (e.g., based on cpu cycles and/or based on cpu time) of the computer processing system 300 are below a threshold level of processing capability, or when the computer processing system 300 becomes essentially idle or in another state, the retraining process of each autoencoder can be performed by the autoencoder architecture 212 to maintain a high level of quality (e.g., accuracy and correctness) of processing data items, which for example each autoencoder was trained to perform such as at an initialization phase of the each autoencoder.

Continuing with the example computer-implemented method 100 of FIG. 1, the label growing iterations phase 114, 116, 118, 120, includes iteratively processing unlabeled data items individually provided into all three inputs 2025, 2035, 2045, of the respective three autoencoders 2022, 2032, 2042, as has been discussed above. While each of the three autoencoders 2022, 2032, 2042, outputs a reconstructed version of the particular unlabeled data item which was provided into all three inputs 2025, 2035, 2045, the output reconstructed version of the particular unlabeled data item from each autoencoder is compared 2028, 2038, 2048, to the input particular unlabeled data item that was provided into all three autoencoders 2022, 2032, 2042. The comparison result indicates a loss of information resulting from the reconstruction of the particular input data item by each of the autoencoders 2022, 2032, 2042. Each of the three loss of information results is then compared 230, 240, 250, to a zero loss of information, which ideally is the best possible reconstruction results. The result of the three comparisons 230, 240, 250, to the zero loss of information reference value, provides three output values indicative of the loss of information by each of the three autoencoders 2022, 2032, 2042.

The three output values indicative of the loss of information by the three respective autoencoders, are then coupled to multi-connection mapping operations and associated structure 260 which couples the three output values indicative of the loss of information to a Boltzmann probability distribution structure and associated functions 270 which generate probability predictions in a probability distribution of three probabilities, in the example. The predicted three probabilities in the probability distribution can then be associated with the particular unlabeled data item. According to the example, as has been discussed above, the label purity/growth controller 332, 116, 118, 120, 270, decides whether to keep the previous probability distribution already associated with the particular unlabeled data item, or to update the probability distribution with the newly predicted three probabilities.

In certain embodiments, the label purity/growth controller 332, 116, 118, 120, 270, maintains and monitors a history of label probability purity over the iterations of processing unlabeled data items and growing labels therefor. According to the example, a label probability purity value history 614 is maintained in each data item record 602 associated with each unlabeled data item.

A label probability purity value 614 can be calculated, by the label purity/growth controller 332, 116, 118, for each probability distribution 606, 608, 610, 612, associated with each unlabeled data item being iteratively processed by the autoencoder architecture 212. One way to calculate a label probability purity value 614 is to square each probability in the probability distribution and then sum all the squared probability values. This value can range from a high value of 1.0 (e.g., when the probability distribution includes one probability that is 1.0 and the other two probabilities are 0.0) to a low value approaching 0.0 (e.g., when all three probabilities in the probability distribution are 0.33).

While iteratively processing all of the unlabeled data items by the autoencoder architecture 212, the label purity/growth controller 332, 116, 118, calculates each label probability purity value and stores a history of label probability purity value(s) 614 in each data item record 602 associated with each unlabeled data item being processed. If the label purity/growth controller 332, 116, 118, monitors a history of label probability purity value(s) 614 associated with a particular unlabeled data item, which is increasing over iterations of processing (closer to the maximum value of 1.0) then the label purity/growth controller 332, 116, 118, 120, may continue to update the probability distribution 606, 608, 610, 612, associated with the unlabeled data item with the newly predicted three probabilities generated by the Boltzmann probability distribution structure and associated functions 270.

On the other hand, the label purity/growth controller 332, 116, 118, can monitor a history of label probability purity value(s) 614 associated with a particular unlabeled data item, which is not increasing over one or more iterations of processing the unlabeled data items by the autoencoder architecture 212. Optionally, in certain embodiments, the label purity/growth controller 332, 116, 118, can monitor a history of label probability purity value(s) 614 that is decreasing (closer to a low value approaching 0.0) over one or more iterations of processing the unlabeled data items by the autoencoder architecture 212. If at least one of the above stop conditions is monitored, the label purity/growth controller 332, 116, 118, can determine to stop 118 the iterative processing 114, 116, 118, 120, of unlabeled data item(s). A label assignment controller 342 may then assign a label, which is associated with a highest probability in a peaking probability distribution, to the particular unlabeled data item(s).

Additionally, the computer processing system 300 may determine whether a highest probability in the peaking probability distribution associated with the at least one processed unlabeled data item is above a high probability threshold value. In response, the computer processing system 300 may add to the set of classified labeled data associated with the label the new labeled data item which is the processed unlabeled data item that has the label automatically associated therewith. That is, when the system 300 determines, with a high level of confidence, that the correct label has been assigned to the unlabeled data item, this assignment of the correct label has created a new instance of correctly labeled data. The system 300, in response, can automatically add the new instance of correctly labeled data to the set of classified labeled data associated with the label. In this way, the amount of labeled data in the set of classified labeled data increases to a larger amount. A classifier associated with the set of classified labeled data can be trained with the larger amount of labeled data in the set of classified labeled data. This can improve the quality of classification of unlabeled data by the trained classifier.

It should be noted that, according to certain embodiments, the label purity/growth controller 332, 116, 118, can monitor the history of label probability purity value(s) 614 and continue the iterative processing of next unlabeled data item(s) until a stop condition is detected, e.g., exceeding a threshold number (optionally a configuration parameter 334, which may be configured by a user of the computer processing system 300) of iterations while continuing to monitor a history of label probability purity value(s) 614 that meets at least one of the conditions discussed above. That is, for example, the label purity/growth controller 332, 116, 118, based on detecting a stop condition determines to stop 118 the iterative processing 114, 116, 118, 120, of unlabeled data item(s), after a threshold number of iterations of processing unlabeled data item(s) meets at least one of the stop conditions discussed above.

For example, the threshold number of iterations value may be configured by a user to two (a configuration parameter 334, which may be configured by a user of the computer processing system 300). The label purity/growth controller 332, 116, 118, can monitor the history of label probability purity value(s) 614 and continues the iterative processing of unlabeled data item(s) until two iterations continue to monitor a history of label probability purity value(s) 614 that is not increasing. Optionally, in certain embodiments the monitoring label purity/growth controller 332, 116, 118, continues until two iterations continue to monitor a history of label probability purity value(s) 614 that is decreasing (closer to a low value approaching 0.0). The above are only examples of how various embodiments may monitor iterations of the label growing process until a stop condition is monitored. There are many variations of the monitoring iterations of the label growing process discussed above.

An Alternative Architecture Including an End-to-End Artificial Neural Network

An alternative artificial neural network architecture 702, according to various embodiments, will be discussed below with reference to FIG. 7. This alternative architecture uses a single autoencoder (e.g., stacked autoencoders) architecture design as an alternative to the autoencoder architecture 212 design approach outlined in FIG. 2.

The end-to-end autoencoder architecture 702 of FIG. 7, according to various embodiments, can be used to replace the engineered system of an autoencoder architecture 212 shown in FIG. 2, and as discussed above, by one monolithic stacked autoencoder architecture 702 to generate the probability distribution 714 (e.g., a very compressed version or representation of the input data item 704) at the very center/bottleneck 714 of the autoencoder architecture 702. It is implemented by stacking two encoder modules 708, 712 (E and e) followed by two decoder modules 716, 726 (d, D). While one pair of encoder 708 and decoder 726 (E, D) autoencodes unlabeled data and then autodecodes (reconstructs/expands) unlabeled data, a second pair of encoder 712 and decoder 716 (e, d) compresses the code 710 to generate the probability distribution 714, and then reconstructs/expands the probability distribution 714 to a reconstructed code 718.

Arrows indicate the forward pass of data in the order: Densely dotted for unlabeled initialization, narrow dashed for labeled pre-training, and solid for joint, iterative training to grow labels. The dash-dotted arrows denote training targets. The symbol |.| 720 in conjunction with the “-” module 720, target input, and an appropriate skip connection 724 constitutes the reconstruction loss. The Boltzmann distribution block 714 implements the label probability loss.

While the solid trapezoid shapes represent the encoder 708 and the decoder 726 modules to generate a compressed representation 710 of the data, the wavy-dashed trapezoids embody the encoder 712 and the decoder 716 to map the compressed representation 710 to its corresponding (predicted) label probability distribution 714. Similar to that shown in FIG. 2, the densely dotted lines indicate the (forward pass) flow of data of unlabeled data from the input 704 in the pre-training/initialization phase. Dashed lines visualize the same for the labeled data applied thereafter at the input 704. Finally the full network is jointly trained by all data, whether labeled data or unlabeled data, at the input 704 employing the label probabilities similar to the discussion above with reference to FIG. 2. In certain embodiments, the label probability purity measure is monitored by a label purity/growth controller that automatically regulates the iterative flow of information in the autoencoder architecture 702.

This example alternative architecture 702 condenses a semi-supervised learning procedure into a single autoencoder 702 with an enforced label assignment unit at the bottleneck 714. This strategy unifies unsupervised autoencoding exploiting the reconstruction loss and fusion of labeled data into a latent space representation.

Example of a Computer Processing System Server Node Operating in a Network

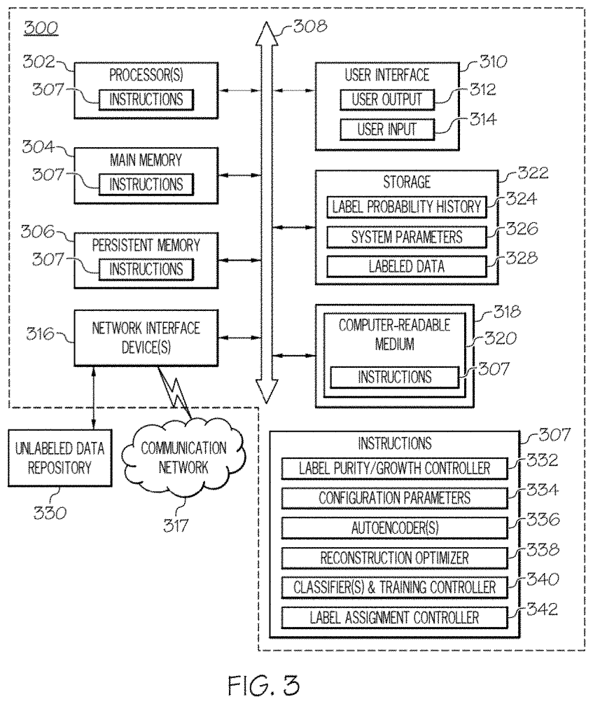

FIG. 3 illustrates an example of a computer processing system server node 300 (also may be referred to as a processing system or a computer system or a computing processing system or a server or a server node, or the like) suitable for use according various embodiments of the invention. The server node 300, according to the example, is communicatively coupled with a communication network 317, which may be coupled to a cloud infrastructure (which may also be referred to as a cloud computing network architecture) that can include one or more communication networks. The cloud infrastructure is typically communicatively coupled with a storage cloud node (which can include one or more storage servers) and with a computation cloud node (which can include one or more computation servers). This simplified example is not intended to suggest any limitation as to the scope of use or function of various example embodiments of the invention described herein.

The example server node 300 comprises a computer processing system/server, which is operational with numerous other general purpose or special purpose computing system environments or configurations. Examples of well-known computing systems, environments, and/or configurations that may be suitable for use with such a computer processing system/server include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems and/or devices, and the like.

The computer processing system/server 300, according to the example, may be described in the general context of computer system-executable instructions, such as program modules, being executed by a computer processing system. Generally, program modules may include routines, programs, objects, components, logic, data structures, and so on that perform particular tasks or implement particular abstract data types. The example computer processing system/server 300 may be practiced in distributed cloud computing environments where tasks are performed by remote processing devices that are linked through a communications network 317. In a distributed cloud computing environment, program modules may be located in both local and remote computer system storage media including memory storage devices.

Referring more particularly to FIG. 3, the following discussion will describe a more detailed view of an example computer processing system server node 300 embodying at least a portion of a client-server system. According to the example, at least one processor 302 is communicatively coupled with system main memory 304 and persistent memory 306.

A bus architecture 308, in this example, facilitates communicatively coupling between the at least one processor 302 and the various component elements of the computer processing system server node 300. The bus 308 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The system main memory 304, in one embodiment, can include computer system readable media in the form of volatile memory, such as random access memory (RAM) and/or cache memory. By way of example only, a persistent memory storage system 306 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 308 by one or more data media interfaces. As will be further depicted and described below, persistent memory 306 may include at least one program product having a set (e.g., at least one) of program modules that are configured to carry out the functions of various embodiments of the invention.

Program/utility, having a set (at least one) of program modules and data 307, may be stored in main memory 304 and/or persistent memory 306 by way of example, and not for limitation, as well as an operating system, one or more application programs, other program modules, and program data. Each of the operating system, one or more application programs, other program modules, and program data, or some combination thereof, may include an implementation of a networking environment. Program modules generally may carry out the functions and/or methodologies of various embodiments of the invention as described herein.

The at least one processor 302 is communicatively coupled with one or more network interface devices 316 via the bus architecture 308. The network interface device 316 is communicatively coupled, according to various embodiments, with one or more networks 317 operably coupled with a cloud infrastructure. The cloud infrastructure includes a storage cloud, which comprises one or more storage servers (or also referred to as storage server nodes), and a computation cloud, which comprises one or more computation servers (or also referred to as computation server nodes). The network interface device 316 can communicate with one or more networks 317 such as a local area network (LAN), a general wide area network (WAN), and/or a public network (e.g., the Internet). The network interface device 316 facilitates communication between the server node 300 and other networked systems, for example other server nodes in the cloud infrastructure.

A user interface 310 is communicatively coupled with the at least one processor 302, such as via the bus architecture 308. The user interface 310, according to the present example, includes a user output interface 312 and a user input interface 314. Examples of elements of the user output interface 312 can include a display, a speaker, one or more indicator lights, one or more transducers that generate audible indicators, and a haptic signal generator. Examples of elements of the user input interface 314 can include a keyboard, a keypad, a mouse, a track pad, a touch pad, and a microphone that receives audio signals. The received audio signals, for example, can be converted to electronic digital representation and stored in memory, and optionally can be used with voice recognition software executed by the processor 302 to receive user input data and commands.

A computer readable medium reader/writer device 318 is communicatively coupled with the at least one processor 302. The reader/writer device 318 is communicatively coupled with a computer readable medium 320, which in certain embodiments may comprise removable storage media. The computer processing system server node 300, according to various embodiments, can typically include a variety of computer readable media 320. Such media may be any available media that is accessible by the computer system/server 300, and it can include any one or more of volatile media, non-volatile media, removable media, and non-removable media.

Computer instructions and data (also referred to as instructions) 307, according to the example, can be at least partially stored in various locations in the server node 300. For example, at least some of the instructions and data 307 may be stored in any one or more of the following: in an internal cache memory in the one or more processors 302, in the main memory 304, in the persistent memory 306, and in the computer readable medium 320. Other computer processing architectures are also anticipated in which the instructions and data 307 can be at least partially stored.

The instructions and data 307, according to the example, can include computer instructions, data, configuration parameters 334, system parameters 326, and other information that can be used by the at least one processor 302 to perform features and functions of the server node 300. According to the present example, the instructions 307 include an operating system, one or more applications, a label purity/growth controller 332, configuration parameters 334, system parameters 326, a set of autoencoders 336, a reconstruction optimizer 338, a set of classifiers and a training controller 340, and a label assignment controller 342, as has been discussed above with reference to FIGS. 1, 2, and 6. The instructions 307 and the operations of the at least one processor 302, in response to executing at least some of the instructions 307, will discussed in more detail below.

The at least one processor 302, according to the example, is communicatively coupled with the server storage 322 (also referred to as local storage, storage memory, and the like), which can store at least a portion of the server node data, networking system and cloud infrastructure messages, data (e.g., streaming data) being communicated with the server node 300, and other data, for operation of services and applications coupled with the server node 300. Various functions and features of the present invention, as have been discussed above and as will be further discussed below, may be provided with use of the server node 300.

The server storage 322, according to various embodiments, includes a label probability history database 324, as has been discussed above with reference to FIG. 6. System parameters 326 and configuration parameters 334 can also be stored in the server storage 322, such that these parameters are useable by various functions and features of the present invention.

In the example, a labeled data store 328 can be stored in the server storage 322. The computer implemented methods, according to various embodiments, often start with a small amount of labeled data and therefrom grow labels that are assigned to previously unlabeled data. This growth of labels possibly also increases the amount of classified labeled data in the labeled data store 328.

An unlabeled data repository 330, or a streaming data source, according to the example, can be located external to, and communicatively coupled with, the computer processing system 300 via the network interface device(s) 316. This unlabeled data repository 330, or a streaming data source, in certain examples of a computer processing system 300, provides a massive amount of unlabeled data to the computer processing system 300. The system 300 can utilize this massive amount of unlabeled data to perform the computer-implemented methods according to various embodiments, thereby growing labels that are assigned to previously unlabeled data.

It is understood that, while the present example uses the labeled data store 328 to store labeled data in a local storage memory 322, and uses the unlabeled data repository 330 to provide to the system 300 large amounts of unlabeled data, other arrangements of alternative system architectures are possible according to various embodiments. For example, a system 300 can access labeled data and unlabeled data both stored in a local storage memory 322. As a second example, a system 300 can access labeled data and unlabeled data both provided from one or more data repositories 330 external to the computer processing system 300 and coupled thereto via the network interface device(s) 316. As a third example, either one of the labeled data or the unlabeled data can be stored in one of a local storage memory 322 or provided from one or more data repositories 330 external to the computer processing system 300. As a fourth example, the other one of the labeled data or the unlabeled data can be provided to the computer processing system 300 from the other one of the local storage memory 322 or from the one or more data repositories 330 external to the computer processing system 300. As a further example, a streaming data source can provide either one of the labeled data or the unlabeled data to the computer processing system 300, via the network interface device(s) 316, and the other one of the labeled data or the unlabeled data can be provided to the computer processing system 300 from either the one or more data repositories 330 or from the local storage memory 322. As another further example, one or more streaming data sources can provide both the labeled data and the unlabeled data to the computer processing system 300, and at least one of the labeled data and the unlabeled data (or both) can be stored in the local storage memory 322. Many different arrangements for providing the labeled data or the unlabeled data to the computer processing system 300 are possible according to various embodiments of the invention.

Example of a Cloud Computing Environment

Various embodiments of the present invention benefit from being implemented using a cloud computing infrastructure. For example, an encoder architecture, such as the example shown in FIG. 2, can benefit from parallelism offered by implementation in a cloud computing infrastructure. A cloud computing node, for example, performs at least a portion of a computer implemented method directed toward initializing and conditioning one or more prototype autoencoders 202, 204, 206, 208, 210. After each prototype autoencoder 202 is initialized and conditioned, it can be copied into a cloud computing node and then trained with a particular one set of classified labeled data thereby customizing parameters of such each prototype autoencoder 202 to form a customized autoencoder representing the particular one set of classified labeled data. In similar fashion, additional prototype autoencoders 202 are copied into respective separate cloud computing nodes and then trained with a particular separate set of classified labeled data thereby customizing parameters of such additional prototype autoencoder 202 to form a respective customized autoencoder representing the particular separate set of classified labeled data. In this way, autoencoder architecture 212 can be distributed across a plurality of cloud computing nodes, e.g., one autoencoder per cloud computing node, which can operate a computer implemented method according to various embodiments by using parallel computing.

In the example shown in FIG. 2, there are shown three autoencoders 2022, 2032, 2042, which could be copied into respective three cloud computing nodes. Further, another separate cloud computing node could implement another portion of the computer implemented method that performs the multi-connection mapping operations and structure 260 and the Boltzmann probability distribution structure and associated functions 270 which generate the probability predictions in a probability distribution structure. With each cloud computing node discussed above can be associated a respective cloud storage node.

The example discussed above illustrates an autoencoder architecture 212 implemented in a parallel computing architecture. Each of the autoencoders 2022, 2032, 2042, can operate in parallel with respect to each other, and then with message passing can communicatively couple the reconstruction outputs 230, 240, 250, from each of the autoencoders 2022, 2032, 2042, to another separate cloud computing node in which such outputs 230, 240, 250, become inputs into the multi-connection operations and structure 260 performed at the another separate cloud computing node. The multi-connection operations and structure 260 are then fused, at another separate cloud computing node, forming the Boltzmann probability distribution structure and functions 270. The above discussion illustrates only one example implementation of autoencoder architecture 212. There are many different ways to implement autoencoder architecture 212, in accordance with various embodiments of the invention.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases

automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

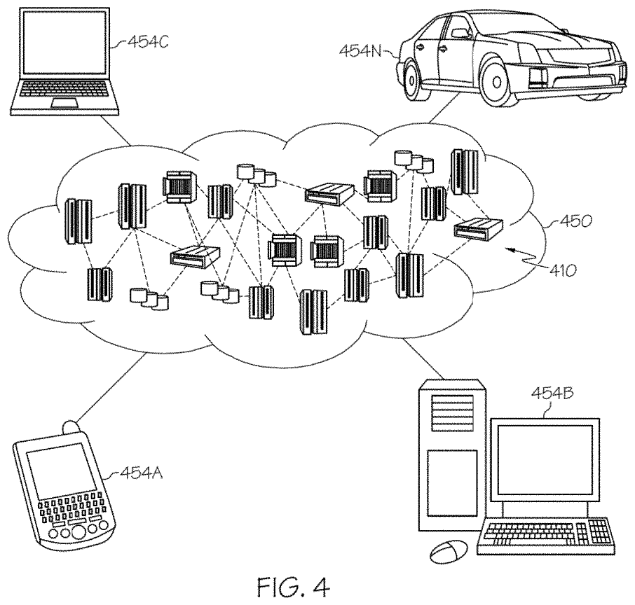

Referring now to FIG. 4, an illustrative cloud computing environment 450 is depicted. As shown, cloud computing environment 450 comprises one or more cloud computing nodes 410 with which local computing devices used by cloud consumers, such as, for example, personal digital assistant (PDA) or cellular telephone 454A, desktop computer 454B, laptop computer 454C, and/or automobile computer system 454N may communicate. Nodes 410 may communicate with one another. They may be grouped (not shown) physically or virtually, in one or more networks, such as Private, Community, Public, or Hybrid clouds, or a combination thereof. This allows cloud computing environment 450 to offer infrastructure, platforms and/or software as services for which a cloud consumer does not need to maintain resources on a local computing device. It is understood that the types of computing devices 454A-N shown in FIG. 4 are intended to be illustrative only and that computing nodes 410 and cloud computing environment 450 can communicate with any type of computerized device over any type of network and/or network addressable connection (e.g., using a web browser).

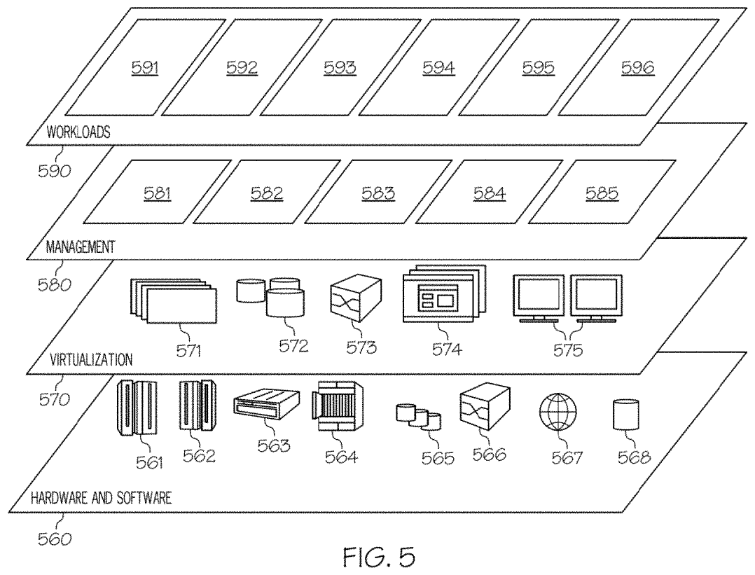

Referring now to FIG. 5, a set of functional abstraction layers provided by cloud computing environment 450 is shown. It should be understood in advance that the components, layers, and functions shown in FIG. 5 are intended to be illustrative only and embodiments of the invention are not limited thereto. As depicted, the following layers and corresponding functions are provided:

Hardware and software layer 560 includes hardware and software components. Examples of hardware components include: mainframes 561; RISC (Reduced Instruction Set Computer) architecture based servers 562; servers 563; blade servers 564; storage devices 565; and networks and networking components 566. In some embodiments, software components include network application server software 567 and database software 568.

Virtualization layer 570 provides an abstraction layer from which the following examples of virtual entities may be provided: virtual servers 571; virtual storage 572; virtual networks 573, including virtual private networks; virtual applications and operating systems 574; and virtual clients 575.

In one example, management layer 580 may provide the functions described below. Resource provisioning 581 provides dynamic procurement of computing resources and other resources that are utilized to perform tasks within the cloud computing environment. Metering and Pricing 582 provide cost tracking of resources which are utilized within the cloud computing environment, and billing or invoicing for consumption of these resources. In one example, these resources may comprise application software licenses. Security provides identity verification for cloud consumers and tasks, as well as protection for data and other resources. User portal 583 provides access to the cloud computing environment for consumers and system administrators. Service level management 584 provides cloud computing resource allocation and management such that required service levels are met. Service Level Agreement (SLA) planning and fulfillment 585 provide pre-arrangement for, and procurement of, cloud computing resources for which a future requirement is anticipated in accordance with an SLA.

Workloads layer 590 provides examples of functionality for which the cloud computing environment may be utilized. Examples of workloads and functions which may be provided from this layer include: mapping and navigation 591; software development and lifecycle management 592; virtual classroom education delivery 593; data analytics processing 594; transaction processing 595; and other data communication and delivery services 596. Various functions and features of the present invention, as have been discussed above, may be provided with use of a server node 300 communicatively coupled with a cloud infrastructure via one or more communication networks 317. Such a cloud infrastructure can include a storage cloud and/or a computation cloud.

Non-Limiting Examples

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although the present specification may describe components and functions implemented in the embodiments with reference to particular standards and protocols, the invention is not limited to such standards and protocols. Each of the standards represents examples of the state of the art. Such standards are from time-to-time superseded by faster or more efficient equivalents having essentially the same functions.

The illustrations of examples described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this invention. Figures are also merely representational and may not be drawn to scale. Certain proportions thereof may be exaggerated, while others may be minimized. Accordingly, the specification and drawings are to be regarded in an illustrative rather than a restrictive sense.

Although specific embodiments have been illustrated and described herein, it should be appreciated that any arrangement calculated to achieve the same purpose may be substituted for the specific embodiments shown. The examples herein are intended to cover any and all adaptations or variations of various embodiments. Combinations of the above embodiments, and other embodiments not specifically described herein, are contemplated herein.

The Abstract is provided with the understanding that it is not intended be used to interpret or limit the scope or meaning of the claims. In addition, in the foregoing Detailed Description, various features are grouped together in a single example embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

Although only one processor is illustrated for an information processing system, information processing systems with multiple CPUs or processors can be used equally effectively. Various embodiments of the present invention can further incorporate interfaces that each includes separate, fully programmed microprocessors that are used to off-load processing from the processor. An operating system included in main memory for a processing system may be a suitable multitasking and/or multiprocessing operating system, such as, but not limited to, any of the Linux, UNIX, Windows, and Windows Server based operating systems. Various embodiments of the present invention are able to use any other suitable operating system. Various embodiments of the present invention utilize architectures, such as an object oriented framework mechanism, that allow instructions of the components of the operating system to be executed on any processor located within an information processing system. Various embodiments of the present invention are able to be adapted to work with any data communications connections including present day analog and/or digital techniques or via a future networking mechanism.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The term “another”, as used herein, is defined as at least a second or more. The terms “including” and “having,” as used herein, are defined as comprising (i.e., open language). The term “coupled,” as used herein, is defined as “connected,” although not necessarily directly, and not necessarily mechanically. “Communicatively coupled” refers to coupling of components such that these components are able to communicate with one another through, for example, wired, wireless or other communications media. The terms “communicatively coupled” or “communicatively coupling” include, but are not limited to, communicating electronic control signals by which one element may direct or control another. The term “configured to” describes hardware, software or a combination of hardware and software that is adapted to, set up, arranged, built, composed, constructed, designed or that has any combination of these characteristics to carry out a given function. The term “adapted to” describes hardware, software or a combination of hardware and software that is capable of, able to accommodate, to make, or that is suitable to carry out a given function.

The terms “controller”, “computer”, “processor”, “server”, “client”, “computer system”, “computing system”, “personal computing system”, “processing system”, or “information processing system”, describe examples of a suitably configured processing system adapted to implement one or more embodiments herein. Any suitably configured processing system is similarly able to be used by embodiments herein, for example and not for limitation, a personal computer, a laptop personal computer (laptop PC), a tablet computer, a smart phone, a mobile phone, a wireless communication device, a personal digital assistant, a workstation, and the like. A processing system may include one or more processing systems or processors. A processing system can be realized in a centralized fashion in one processing system or in a distributed fashion where different elements are spread across several interconnected processing systems.

The corresponding structures, materials, acts, and equivalents of all means or step plus function elements in the claims below are intended to include any structure, material, or act for performing the function in combination with other claimed elements as specifically claimed.

The description of the present application has been presented for purposes of illustration and description, but is not intended to be exhaustive or limited to the invention in the form disclosed. Many modifications and variations will be apparent to those of ordinary skill in the art without departing from the scope of the invention. The embodiment was chosen and described in order to best explain the principles of the invention and the practical application, and to enable others of ordinary skill in the art to understand the invention for various embodiments with various modifications as are suited to the particular use contemplated.

The Inventors Provide Below a More Detailed Technical Discussion of Various Embodiments and Research Conducted by the Inventors

Objective

In machine learning, supervised training is the process of optimizing a function ƒ_{θ} with parameters θ to predict (continuous) labels l from input data x such that the prediction [symbol] =ƒ_{θ}(x) is close (continuous case) or equal (discrete case) to the ground truth l. In real-world scenarios we are typically confronted with a limited set of labeled data {(x, l)} due to the labor-intensive process of building the associated x↔l. However, in the era of Big Data a massive set of unlabeled data {x̅} might be available from data mining procedures. This proposal discloses a technique to increase a small set of labeled data {(x, l)} exploiting massive amounts of unlabeled data {x̅}.

Preliminaries

The following introduces notation and fields of research involved in our approach. Conceptual formulae key get framed.

Elementary Probability Theory

Here, we outline a procedure given data and labels such that

$$\vert \{ ( x , l ) \} \vert ≪ \vert \{ \overline{x} \} \vert$$

there is a process P that generates labeled data

P({(x,l)},{x̅})={(x′,l′):x′∈{x̅}}

with a conditional probability distribution p satisfying

p′(l′|x′)˜p(l|x)

which loosely reads:

Given the set of labeled data {(x, l)}, associate labels l′ to (a subset of) the unlabeled data x′E{x̅} such that the probability of the label l′ assigned to x′, p(l′|x′), is equivalent to the distribution of the given labeled data, p(l|x).

In fact, a proper definition of the above relation is one aspect of research.

The notation p(a|b) denotes the probability of value a given value b. More specifically: Given the joint probability p(a, b) to observe values a and b, the probability p(b) to observe a value b irrespective of a is computed by

p(b)=Σ^{a}p(a,b).

Given that the value of b is certainly known, the probability to observe a needs to be normalized by p(b) such that Σ^{a}p (a|b)=1, thus p(a|b)=p(a, b)/p(b). The same argument holds when swapping a and b such that by definition:

p(a,b)=p(a|b)p(b)=p(b|a)p(a).

A convenient introduction provides Peter Shor's 2010 lecture notes on probability theory (Shor 2020).

Information Theory to Characterize Distributions

A standard to measure the deviation of two probability distributions reads

Δ[p,q]=H[p,q]−H[p,p]=−(log q)ₚ+(log p)ₚ≥0

defining the cross entropy functional of two probability distributions over (discrete) values i as H[p, q]=−Σⁱpᵢ log qᵢ with [symbol] . [symbol] ₚ the expectation value w.r.t. the distribution p and i labeling a state that is observed with probability pᵢ. Both probability distributions should be properly normalized such that [symbol] 1 [symbol] ₚ= [symbol] 1 [symbol] _{q}=1. Note, that Δ[p, q]≠Δ[q, p], i.e. it is not a metric by intention:

Δ[p, q] computes the difference in bits to encode states i with log 1/qᵢ bits vs. log 1/pᵢ given the state i has probability pᵢ. It can be shown that q=p is the optimal choice. Given a generative function ƒ_{θ} with parameters θ sampling states i with probability qᵢ, optimizing ƒ_{θ} by tuning θ will drive ƒ_{θ} towards sampling i with probability pᵢ. In this sense q and p are asymmetric.

Typically, {x}∩{x̅}=Ø and {l′}∪{l}≠{l}, i.e. instances x′ of unlabeled data have no exact representative in the labeled data x=x′ (otherwise we could trivially assign l to x′), and there might exist labels not covered by the set of known labels {l}. Hence, we cannot form an index i common to p and p′ in order to evaluate the functional Δ[p, q].

Some remark on “−log p”: Let's assume we estimate pᵢ=nᵢ/N with N=Σⁱnᵢ where nᵢ is the number of observations of state labeled by i. Then, −log pᵢ=log_{N}−log nᵢ is proportional to the difference in bits to enumerate all observations versus labeling observations in state i, only. Since i groups observations into a single state, −log pᵢ might be viewed as a measure of the information represented by the i: If nᵢ=N then we describe all observations by a single state. On the other end of the spectrum, where nᵢ=1, we label each observation with a different i, so given i we immediately know the observation it refers to. In this sense i is maximally informative, while for nᵢ=N, the label i does not tell us anything about the observation. The concept stems from Shannon with details presented in (Shannon 2001).

Decision Theory to Reduce Distributions for Inference

Assuming a p′(l′|x′) has been determined by P, a decision step needs to be taken in order to assign a unique label to the data x′. Unless p(l′|x′)=δl(x′)′ provides unique labels (x′, l(x′)), in general, we would incorrectly label x′ by l′ with probability p′(l′|x′). Let us define a loss L(l, l′)≥0 to quantify the strength of error assigning the incorrect label l′ to x′ instead of the correct one l. Obviously, L(l, l)=0 and, in general L(l, l′)≠L(l′, l). The overall loss to be minimized reads

[symbol]

L [symbol] _{p′}=Σ^{l′,x′}L(l(x′),l′)p′(l′|x′)p′(x′)=Σ^{x′}p′(x′)L′(x′)

While L(l, l′) is fixed by design, and p(x′) is defined by the (potentially growing amount of) data {x̅}, p′(l′|x′) is determined by our procedure P. [symbol] L [symbol] ₚ, should be minimized by individually minimizing

L′(x′)=Σ^{l′}L(l(x′),l′)p′(l′|x′)

for each x′ where l(x′) is the true label of x′. A some more detailed discussion is given in (Bishop 2006).

Definition of p′˜p by Appropriate Loss Function L

In the sections below, a concept to correlate p to p′ is based on the substitution of raw data labels (x′, l′) with (x′, p(l′|x′)) when applying machine learning to implement P.

While we will

initialize labeled data (x, l) by (x, p′(l′|x)=δ_{u′}); and

unlabeled data will get set to (x′, p′(l′|x)=|{l}|⁻¹=const.).

Any machine-learning assisted procedure P that generates a p″(l′|x′) allows to add the following two losses for the label distribution for a given x′:

entropy minimization: [symbol] ₑ˜H[p″, p″] or [symbol] ₑ˜−G^{α}[p″]=− [symbol] p″^{a} [symbol] _{p″} with α>0 in order to optimize p″ towards δ_{u′}.

similarity loss minimization: [symbol] ₛ˜Δ[p′, p″] driving p″ to the label distribution p′

The former definition of

$${G}^{α} = {〈 {p}^{α} 〉}_{p}$$

can be actually used to monitor classification purity, since

0< [symbol] G^{α} [symbol] ≤1

with 1 if and only if p″(l′|x′)=δ_{l′l″(x′)} labeling x′ by l″ where the second loss and the initial conditions for labeled data {(x, l)} encourage l″=l. The average [symbol] . [symbol] is over all x′.

Applying an iterative procedure where p″→p′ in steps 1, 2, . . . , n, . . . the evolution of the entropy of the label probability distribution is expected to follow

$${lim}_{n \to ∞} 〈 {G}_{n}^{α} 〉 = 1$$

Then, if lim_{n→∞}p′ₙ(l′|x′)=δ_{l′l(x′)} for the generic loss defined, it holds

$${lim}_{n \to ∞} {〈 {L}_{n} 〉}_{{p}^{′}} = {\sum }^{{x}^{′} , {l}^{′}} L ( l ( {x}^{′} ) , {l}^{′} ) {δ}_{{l}^{′} l ( {x}^{′} )} {p}_{n}^{′} ( {x}^{′} ) = {\sum }^{{l}^{′}} L ( {l}^{′} , {l}^{′} ) = 0$$

However, in practice the true label l(x′∈{x̅}) of unlabeled data is unknown, hence the value of L(., l′) cannot be computed explicitly to be used as a loss. All we can hope for is to engineer a process P such that after initialization of the label distribution for both, labeled and unlabeled data, the p′ₙ is iteratively adjusted to correctly converge. The entropy minimization loss fosters p′ₙ to peak, and the similarity loss minimization makes p′ₙ stay close to its value p′ₙ from the previous iteration. By training a single system with labeled and unlabeled data we achieve the correlation p˜p′.

The contribution of the two losses will have a hyperparameter λ. Note, that a second parameter can be scaled out, since we are not interested in the absolute value of the total loss function [symbol] . In addition, the second loss could be biased by a term G^{α}[p′]: By design, a sharply peaked p′ indicates confident labeling, i.e. p″ should be pushed towards it by Δ[p′, p″]. Reversely, a flat p′ should get updated by p″ predicted through P, i.e.

[symbol]

ₛ˜G^{α}[P′]Δ[p′,p″]+(1−G^{α}[p′])Δ[p″,p′]

such that the total loss for the label distributions reads:

$${ℒ}_{l} [ {p}^{′} , {p}^{″} ] = {λℒ}_{e} + {ℒ}_{s} = λ H [ {p}^{″} , {p}^{″} ] + {G}^{α} [ {p}^{′} ] Δ [ {p}^{′} , {p}^{″} ] + ( 1 - {G}^{α} [ {p}^{′} ] ) Δ [ {p}^{″} , {p}^{′} ]$$

Approaches to Construct P

Since typically {x}∪{x′}=Ø, naturally a concept of closeness needs to be defined. An element we exploit in the methods below is a parametrized function A(x)= [symbol] such that the reconstruction loss

[symbol]

(x)˜D(x,y=A(x))=|x−\hat{x}|

defines a (latent) space through machine learning.

Note that opposed to Δ[p, q], we have D (x, y)=D (y, x), and similarly to Δ we have D≥0 implied by the norm |.| and D(x, y)=0 ⇔x=y.

Closeness is introduced by conceptually coupling D to p employing the observation that an A=Aₗ trained on labeled data (x, l=const) should yield D (x′, Aₗ(x′))≈0 for unlabeled data x′∈{x̅} where the ground truth label l′=l.

The following details on two concrete implementations that materializes this vague statement into a procedure P. It is noted that the notion coupling by training involves the proper description of a learning schedule with

initialization phase where A's parameters are adjusted based on the input data ({(x, l)}, {x̅})

iteration phase to learn p′(l′|x′) monitoring the variation

δGₙ^{a}=δₙ^{a}( [symbol] Gₙ^{a} [symbol] , [symbol] Gₙ₋₁^{a} [symbol] , . . . [symbol] G₀^{a} [symbol] )

of the performance measure [symbol] Gₙ^{a} [symbol] with the initial condition

$$〈 {G}_{0}^{α} 〉 = \frac{{\vert \{ l \} \vert}^{- α} \cdot \vert \{ \overline{x} \} \vert + 1 \cdot \vert \{ ( x , l ) \} \vert}{\vert \{ \overline{x} \} \vert + \vert \{ ( x , l ) \} \vert} = \frac{{\vert \{ l \} \vert}^{- α} + ϵ}{1 + ϵ} = {( \frac{1}{{N}_{l}} )}^{α} + ( 1 - 1 / {N}_{l}^{α} ) ϵ + 𝒪 ( {ϵ}^{2} )$$

with Nₗ=|{l}| the number of distinct labels. We assume the amount of labeled data is small compared to the data to label, ϵ=|{(x, l)}|/|{ [symbol] }|<<1. and stopping criterion δG_{N}^{a}≈0 after N iterations where typically, but not necessarily $\langle G\hat{ }\alpha_N\rangle\lesssiml$.

An Engineering Solution

Let us pick Nₗ autoencoder artificial neural networks {A_{θ}^{l′}} to predict labels l′ with

$$\vert {A}_{l ′} \vert = \vert \{ l \} \vert = {N}_{l}$$

by tuning its parameters θ=θ_{l′}—dropping the l′-index to not further clutter the notation. Ideally, each A_{θ}^{l′} is supposed to obey

$${p}^{′} ( {l}^{′} \vert {x}_{l} ) = {p}_{β} ( {E}_{l ′ \vert l} ) = {p}_{l ′ \vert l} = {δ}_{ll ′}$$

defining the Boltzmann distribution

p_{β}(E)=e^{-βE}/Z where Z=Σ^{E}e^{-βE}

and

E_{l′|l}=σ(D(xₗ,A_{θ}^{l′}(xₗ)))−1 with

$$σ ( z ) = \frac{{e}^{z} - {e}^{- z}}{{e}^{z} + {e}^{- z}}$$

mapping the interval [0, ∞) to [0, 1), and xₗ indicates an x from the labeled data (x, l). The free parameter β>0 denotes the inverse temperature available to control δGₙ^{a} from iteration to iteration. Now we can explicitly express

−βE_{l′|l}=β/(1+e^{z}) with |z|=z=D(xₗ,A_{θ}^{l′}(xₗ))≥0

absorbing scaling factors of 2 into the definition of β and D, respectively. Hence, while perfect reconstruction z≈0 will yield a (unnormalized) log-probability log Zp_{β}˜β, as z→∞ the quantity log Zp_{β} exponentially drops to zero. Hence, a z>>1 might lead to numerical instabilities when a quantity exp(exp(−z)) is evaluated: a large z generates a small y=exp(−z) that generates a finite $\exp y\approx 1+\exp(−z)\gtrsim1$. Therefore we simplify

$$β {E}_{l ′ \vert l} = β D ( {x}_{l} , {A}_{θ}^{l ′} ( {x}_{l} ) ) = β {D}_{l ′ \vert l} \geq 0$$

For stable normalization of the probabilities p_{β}=e^{-βE}/Z by Z=Σ^{E}e^{-βE} we implement: p_{β}→p_{β}+ϵ with 10⁻³≈ϵ<<1. This way, Z≥Nₗϵ>0.

Typically, β=1, but a value larger (lower temperature), lets deviate bad autoencoder reconstructions more significantly from zero in terms of log-probabilities −βE≤0 such that the probability distribution normalization (softmax operation) singles out the best reconstruction more prominently. In practice e^{-βD} drops to zero quickly as the reconstruction error D increases. Alternatively,

$${Zp}_{β} = 1 / ( β {D}_{l ′ \vert l} + ϵ )$$

with 1>>ϵ>0 a stabilization parameter again, and z=Σ^{E=D}Zp_{β}.

Collegially speaking, if we feed an xₗ into the set of autoencoders A_{l′}, we want the reconstruction [symbol] _{l′}=A_{θ}^{l′}(xₗ) to be good when the label l of the data x coincides with the label l′ represented by the autoencoder A_{θ}^{l′}, l=l′, and bad when l≠l′. This way {A_{θ}^{l′}} represents a discriminator to the data x.

To grasp the control of β over δG^{a} let us determine its impact on p′(l′|xₗ), thus [symbol] p′ [symbol] _{p′}=G^{a} for

$$high temperature limit , β \to 0 and low temperature limit , β \to ∞ .$$

Rewriting

$${p}_{β} ( E ) = {( {\sum }_{{E}^{′}} {e}^{- β ( {E}^{′} - E )} )}^{- 1}$$

let us approximate

pβ(E)⁻¹=Σ^{E′}1−β(E′−E)+ [symbol] (β²)=Nₗ(1−β(Ē′−E))+ [symbol] (β²)

with the mean Ē′ₗ=1/NₗΣ^{l′}E_{l′|l}. Exploiting the definition of the energy E_{l′|l}, and 1/(1−ϵ)=1+ϵ+ [symbol] (ϵ²) we end up with

$${p}^{′} ( {l}^{′} \vert {x}_{l} ) = {p}_{{l}^{′} \vert l} = \frac{1}{{N}_{l}} + β \frac{{\overline{σ}}_{{l}^{′}} - {σ}_{{l}^{′} \vert l}}{{N}_{l}} + 𝒪 ( {β}^{2} )$$

where, again, the mean σ̅ₗ′=1/NₗΣ^{l′}σ_{l′|l}.

Note that the dominant term for β→0 is the constant distribution with value Nₗ⁻¹ used to initialize unlabeled data. The contribution linear in β adds fluctuations as expected: Would a specific autoencoder A_{θ}^{l} yield good reconstruction while—at the same time—all others yield significant errors relative to it, we would obtain σ_{l′|l}≈1−δ_{ll′}, hence $\bar\sigma_l′\lesssiml$ such that

p_{l|l}≈(1+β)/Nₗ>1/Nₗ≈p_{l′≠l|l}

Aₗ outputs highest probability.

As β→∞, the probability p_{β}(E) gets dominated by contributions exp(β(E−E′)) with E′≤E. In fact, any E′ with E′<E enforces p_{β}(E) to zero, i.e. in order to obtain a non-zero p_{β}(E) in the limit β→∞, E≤E′ for all E′ where all terms exp(β(E−E′)) with E′>E vanish to zero such that

$${lim}_{β \to ∞} {p}_{β} ( E ) = δ ( E - {E}_{0} ) with {E}_{0} \leq E$$

which immediately translates into

$${lim}_{β \to ∞} {p}_{{l}^{′} \vert l} = {δ}_{{ll}^{′}}$$

with l′ determined by the corresponding A_{l′=1} having best reconstruction of xₗ. This way the low temperature limit is able to magnify the best performing Aₗ to generate a label distribution close to the one we set for labeled data (x, l). Lowering the temperature over the course of iterative training could be viewed as adiabatically finding the optimum solution, cf. simulated annealing (Kirkpatrick, Gelatt, and Vecchi 1983).

Equipped by

the set of labeled and unlabeled data, {(x, l)} and {x̅}, respectively,

assigning their corresponding initial label probabilities

$${p}_{0}^{′} ( {l}^{′} \vert {x}_{l} ) = {δ}_{u} , and {p}_{0}^{′} ( {l}^{′} \vert \overline{x} ) = {N}_{l}^{- 1} = const . ,$$

respectively,

the set of discriminating autoencoders {A_{θ}^{l}}, one for each label group,

the objective to minimize the loss [symbol] ₗ=Δ [symbol] ₑ+ [symbol] ₛ, specifically for batches we apply averaging over the batch, i.e. [symbol] ₗ→ [symbol] [symbol] ₗ [symbol] ,

the classification purity measure [symbol] G^{α} [symbol] to monitor label progress,

the inverse temperature β to control the purity of a predicted label probability distribution p′(l|x)=p_{β}(E(x)) with E(x)=D(x, A_{θ}^{l}(x)),

there exists a plethora of learning schedules to iteratively update the set of learning parameters {θₗ} of autoencoders {A_{θ}^{l}} by stochastic gradient descent exploiting backpropagation:

{θₗ} [symbol] θ→θ−η∂_{θ} [symbol] ₗ

with learning rate η>0. Note that although each class labeled by 1 gets assigned its own autoencoder A_{θ}^{l} their reconstruction loss that is interpreted as probability distribution over all labels gets optimized by minimizing [symbol] ₗ. In particular, the better one A_{θ}^{l} performs, the less the others A_{θ}^{l′≠l} are allowed to perform due to conservation of probability. This negative correlation can be amplified by increasing the inverse temperature β. In fact, β can be an additional learning parameter if not used as a control.

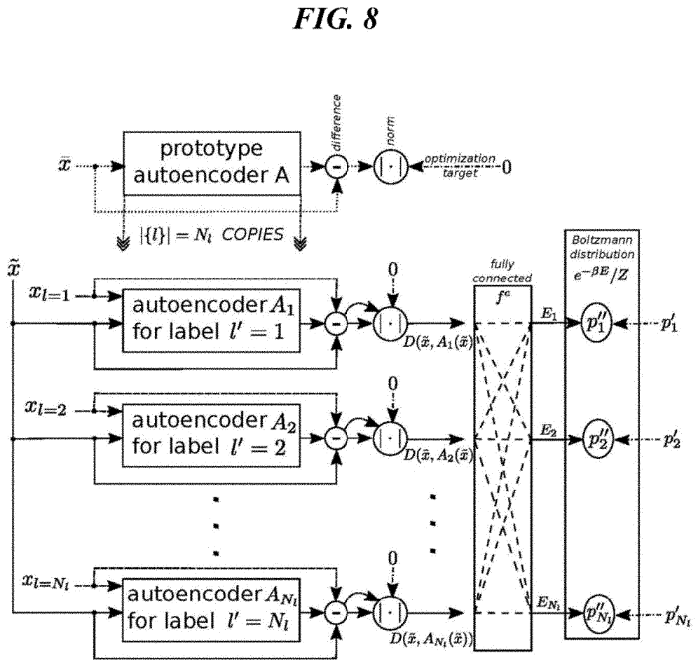

FIG. 8 illustrates a cartoon of engineered network architecture to predict the label distribution p′(l′|\tilde{x}) on all data given with proper pretraining of a prototype autoencoder A to be copied and specialized given the labeled data (x, l). Arrows indicate the forward pass of data in the order: Densely dotted for unlabeled initialization, narrow dashed for labeled pretraining, and solid for joint, iterative training to grow labels. The dash-dotted arrows denote training targets. The symbol |.| in conjunction with the “-” module, target input, and an appropriate skip connection constitutes the reconstruction loss. The Boltzmann distribution block implements the label probability loss [symbol] ₗ[p′, p″]. A module of fully connected layers with learnable weights c might be plugged in front, so that relation Eₗ=Dₗ might be learned to become the more general rule Eₗ=fₗ^{c}(D₁, D₂, . . . , D_{N}_{ₗ}); in its simplest form, a linear transformation Eₗ=ΣⁱcₗᵢDᵢ with Nₗ² weights cₗᵢ to be learned.

The initialization might be achieved by training a prototype autoencoder A_{θ} on the unlabled data simply optimizing reconstruction: [symbol] ₚ=|x̅−A_{θ}(x̅)|. Then, the parameters θ are copied Nₗ times to form a set {θₗ=θ} associated with identical autoencoders {A_{θ}^{l}}. Thereafter, these become individually trained per class by the respective labeled dataset {(x, l)} optimizing [symbol] ₚ.

It follows the training iteration where in each iteration step n=1, 2, . . . , N all data and their associated label probability function p′ₙ=p″ₙ₋₁ is set as ground truth, training the {A_{θ}^{l}} by their predicted label probability function p″ₙ by means of

$${ℒ}_{l} ⌈ {p}_{n}^{′} , {p}_{n}^{″} ] = {ℒ}_{l} ⌈ {p}_{n - c}^{″} , {p}_{n}^{″} ] by the iterative update {p}_{n}^{″} \to {p}_{n + c}^{′} with c \geq 1$$

a free parameter typically set to c=1. A stopping criterion is based on [symbol] Gₙ^{a} [symbol] which should increase and converge to 1 as n→N. The monotone increase of βₙ˜n can foster this process.

A drawback of our approach is the dependence of parameters θ to be tuned growing linearly with the number of label groups N₁. However, it also provides an opportunity to add an autoencoder A_{θ}^{N}^{ₗ} should the learning schedule identify label probability distributions that have low Gₙ^{a} over many iterations indicating the existence of an unknown class.

End-to-End Artificial Neural Network

The following outlines an artificial neural network architecture that condenses the semi-supervised learning procedure into a single autoencoder with enforced label assignment unit at the bottleneck. This strategy unifies unsupervised autoencoding exploiting the reconstruction loss and fusion of label data into the latent space representation.

Let us start with a standard autoencoder A(x)=\hat{x} which is composed of an encoding unit E (x)=z and a decoding unit D(z)=\hat{x} with latent state representation z. Training minimizes the loss |x−A(x)|. Traditionally people take the auto-encoded data {z} from the training set {x} to perform clustering. Then labeled data (x, l) induce latent data points zₗ from which cluster labeling might be inferred.

Here we nest into A a second autoencoder that maps latent vectors z to the label distribution p″, p_{β}(e(z))=p″ and back to the latent space, d(p″)= [symbol] . As in our engineering approach, the encoded signal e(z) gets interpreted as energies of a Boltzmann distribution, p_{β}. The full mapping reads:

A=D∘d∘p_{β}∘e∘E.

However, would we train p″ to match p′=1/Nₗ it essentially establishes an information blockade, because the decoder D∘d would need to regenerate all kinds of unlabeled images from the same constant label probability distribution at the very bottleneck of A. Therefore, a skip connection is added to let information flow from the latent state variable z to the reconstructed counterpart [symbol] in the decoder. In particular:

[symbol]

=d(p″)+u(z).

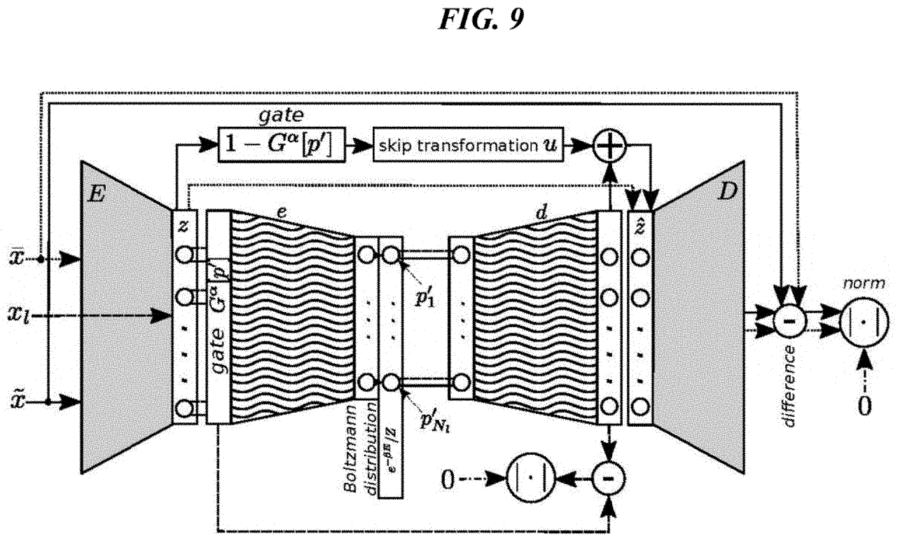

FIG. 9 illustrates a cartoon of a single autoencoder A design as an alternative to the approach outlined in FIG. 8. While the solid trapezoid represents the encoder-decoder module to generate a compressed representation z of the data, the wavy-dashed trapezoids embody the encoder decoder to map z to its corresponding (predicted) label probability distribution p″. As in FIG. 8, densely dotted lines indicate the (forward pass) flow of data of unlabeled data x̅ in the pretraining initialization phase. Dashed lines visualize the same for the labeled data applied thereafter. Finally the full network is jointly trained by all data \tilde{x} employing the label probabilities p′ᵢ with i=1 . . . Nₗ. Its purity G^{α}[p] automatically regulates the flow of information then.

So feeding data x into the network generates a reconstruction

[symbol]

=D[d(p_{β}(e(E(x))))+u(E(x))].

or equivalently

$$A = D ∘ ( d ∘ {p}_{β} ∘ e + u ) ∘ E .$$

The more information flows through u, the more the training is unsupervised. Ideally u=1 and d=0 for unsupervised samples, and u=0 for supervised learning. Similar to our construction of [symbol] ₗ in section, we could gate the bottleneck by means of G^{α}, i.e.

u→(1−G^{α}[p′])u and d→G^{α}[p′]d.

Now, in order to train the network the following loss is optimized in the same way the training iterations were outlined above:

$${ℒ}_{f} = {λ}_{R} \vert \hat{x} - x \vert + {λ}_{r} \vert \hat{z} - z \vert + {ℒ}_{l}$$

with [symbol] ₗ the label probability loss function previously used, and applied to the very bottleneck of A, i.e. the onto the output of p_{β}.

Although not required per se, network pre-training might be beneficial employing an initialization phase such as:

train D∘E on all data optimizing |x−D(E(x))|, only

train d∘p_{β}∘e on labeled data optimizing [symbol] ₗ+|z−d(p_{β}(e(z)))| with z=E(x)

Novelty of Methodology & State of the Art

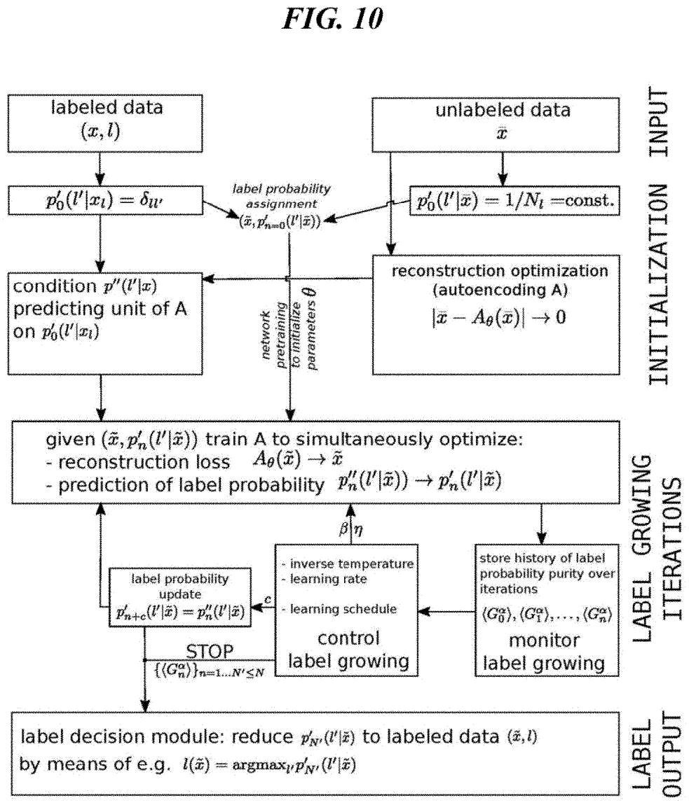

FIG. 10 summarizes the novel technique we present here in order to grow labels given a small set {(x, l)} of labeled data that infer labeling onto the unlabeled dataset {x̅}. FIGS. 8 and 9 depict specific implementations of network architectures used in the workflow.

FIG. 10 illustrates a flow chart of data processing pipeline for automatically labelling data x̅ from a (small) set of labeled data (x, l).

In general, semi-supervised/active learning research typically concerns model training and inference from a mixture of labeled and unlabeled data. There exists rich literature focusing on different aspects:

(Nartey et al. 2020):

Method: The work implements a scheme that incrementally adds unlabeled data to the initial set of labeled data. In each iteration a number of samples from the unlabeled data with highest confidence score for classification is picked. The class (pseudo-)labels and scores is inferred by the model trained on the labeled data subsequently applied to all unlabeled data. In particular, a loss Lₛₜ gets defined that incorporates both, a matrix with binary elements [symbol] _{t,n}, for each unlabeled sample indexed by t to belong to class n, and a networks predicted class probability Pₙ. First, [symbol] results from optimizing Lₛₜ fixing the network parameter weights W. An (arbitrary?) parameter k>0 allows [symbol] _{t,n}=0 for all t for some n values. A second phase fixes [symbol] and optimizes W on the same Lₛₜ. Both steps get iterated till convergence.

Our Differentiator: However, in our approach training data is not iteratively added based on thresholding Pₙ in order to obtain [symbol] . Instead, we assign probability distributions to all (labeled and unlabeled) samples upfront to let them gradually evolve through optimization of our neural network architecture. Information of labeled data is introduced through conditioning of the artificial neural network in the initialization phase which might need to be repeated from iteration to iteration, cf. paragraph Decay of Information from the Initialization Phase in section entitled Label Growing. Moreover, our engineering approach, as illustrated in FIG. 8, is tailored to handle imbalance of the labeled class representatives: a separate autoencoder exists for each class to be conditioned on labeled data associated.

A conceptual aspect of our invention couples the numerical estimate of the label probability p″ to the reconstruction (loss) of an autoencoder which does not require the existence of labels. When available, label information is fused into our system to condition the training process towards improved labeling of the data to classify.

(Chen et al. 2020):

Method: Recently, semi-supervised pre-training and fine-tuning of networks by a small amount of labeled data has been discussed in based on experiments with the ImageNet dataset. Similar to our approach the work pre-trains a network with unlabeled data and fine-tunes by labeled data to subsequently train it again on all data available—referring to this last, 3rd phase as distillation.

Our Differentiator: However, our approach employs a more unified view regarding labels by starting off with a label distribution that is subsequently and iteratively refined by monitoring and controlling a label purity measure. Moreover, we do not rely on the engineering of a contrastive representation to be learned. In our framework the latent data representation is intrinsically embedded into an autoencoder such that its reconstruction loss defines an inter-class, problem-independent distance measure. Also, the end-to-end artificial neural network in FIG. 9 constructs a single monolithic network to be trained with automatic gates to handle labeled and unlabeled data. In fact, the notion of (un)labeled data gets blurred by the iterative label growing phase.

(Imani et al. 2019):

Method: An emerging field, Hyper-Dimensional Computing, represents objects by (random) vectors in a high-dimensional Euclidean space (dimensionality larger than order of 1k). In 2019, a framework, SemiHD has been introduced to perform classification on a given set of labeled data in the hyper-dimensional space to iteratively add unlabeled data to labeled data most close in the hyper-dimensional space. Assignment of a given percentage of the unlabeled data to a class is performed through ranking by distance.

Our Differentiator: Our approach goes beyond this work by defining and iteratively evolving a probability distribution over the class labels where the strict notion of labeled and unlabeled data is lost. No explicit, hand-crafted phase of assigning unlabeled data to the set of labeled data is required. In addition, while the vector representation in hyper-dimensional computing is randomly picked, our encoding of data in terms of vectors in latent space is determined by the well-defined reconstruction error. A notion of closeness is introduced by our procedure of conditioning an autoencoder for each class with the aid of the labeled data.

(Zhao et al., n.d.):

Method: Last but not least, this invention application presents a method and system for active learning of a classifier from a set of labeled and unlabeled data. Two scores based on exploitation and exploration guide a distributed compute system in picking labels for unlabeled data in an iterative fashion. The exploitation score indicates how well an unlabeled data point is represented by the space covered by the set of labeled data. In contrast, the exploration score characterizes unlabeled data outside the space spanned by labeled data. Loosely, these concepts are related to intra- and inter-class distances of a given fixed class in (latent) representation space.

Our Differentiator: As mentioned earlier, an aspect of our disclosure makes use of the unsupervised reconstruction loss (of an autoencoder). Our (deep learning) model does not directly train on probability distributions to be provided as explicit labels; labels solely condition our network in the initialization phase. The iterative training is based on probability distributions p′ over class labels. It removes the notion of labeled and unlabeled data. After the iteration did converge by means of a purity measure G^{α}, a final post-processing step converts the p′ into labels associated with corresponding data.

Proof of Concept

As a first test of our methodology we apply the procedure of FIG. 10 to the MNIST dataset. While 90% of all class labels are randomly stripped for {x̅}, 10% remain to form the labeled dataset {(xₗ, l)}. We employ the engineering approach of FIG. 8. In summary, it comprises the following three stages:

autoencoder initialization: train a prototypic autoencoder on all data

autoencoder conditioning: duplicate autoencoder from stage 1 to have one for each class, and continue reconstruction training of each w.r.t. class-labeled data

label growing: for all data let evolve the probability distributions assigned to the data sample by optimizing towards peaking distributions

Autoencoder Initialization

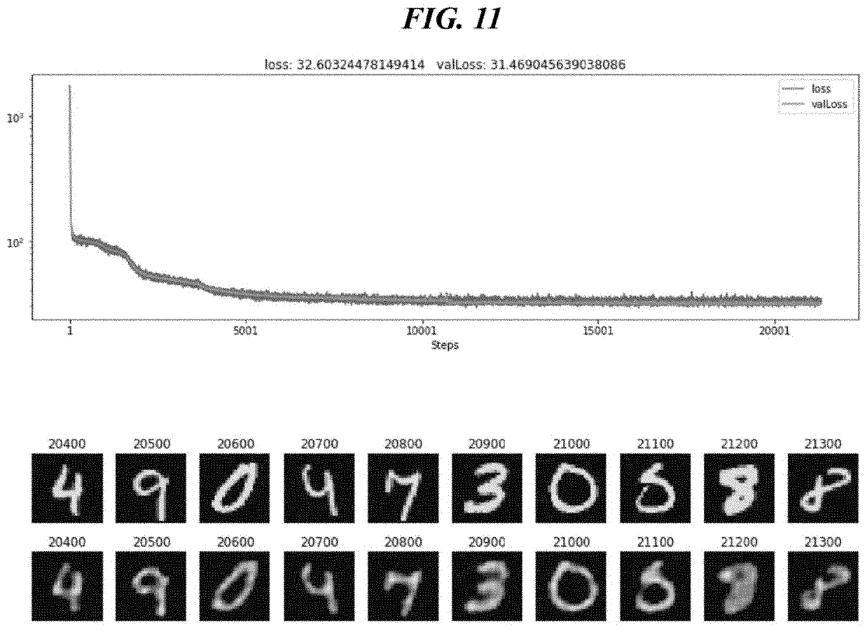

FIG. 11 depicts an evolution of the autoencoder reconstruction loss (represented by a curve in the chart) while training a shallow network with 6 hidden layers and small-sized 3×3 convolutional kernels. A fraction of data is hold-out to validate the loss for data not trained on (orange curve). MNIST consists of about 60k sample images. For loss validation 1% has been split apart.

FIG. 11 illustrates an evolution of reconstruction loss |x̅−A_{θ}(x̅)| for MNIST handwritten digits trained on a convolutional autoencoder with order of 1k parameters. Below is shown samples of input (upper row) and output imagery (lower row). Steps denotes the forward and backward pass of batches of 100 images. 40 epochs have been executed.

Rapid drops in loss indicate a phase where the network qualitatively learned to optimize. Quickly it converges the randomly initialized weights such that it simply returns a constant background value as reconstruction (up to Step˜2000)—a meta-stable solution to approximate a binary image with majority of its pixels equal to zero (background of digit). Subsequently (beyond Step 2000) refinement adjusts to an acceptable reconstruction. The lower two rows of FIG. 11 depict random representatives of handwritten digits: input (top) and output (bottom) of the autoencoder for Steps˜20k-21k, respectively.

Autoencoder Conditioning

For the second stage the prototypic autoencoder A from the previous one is duplicated to assign an individual per class, A_{l′}, to further evolve its weights. Specifically, A_{l′} gets conditioned to perform well on auto-encoding the data of class 1, i.e. reconstruction is optimized to minimize |A_{l′=l}(xₗ)−xₗ|.

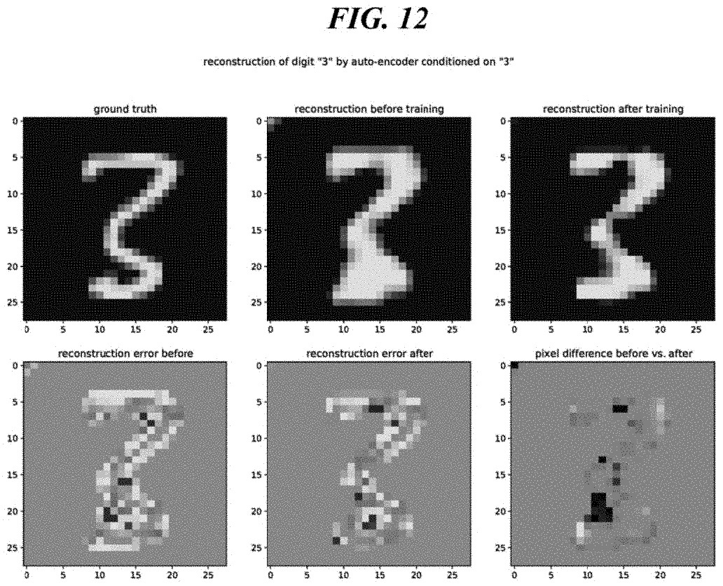

FIG. 12 exemplifies the process of conditioning the autoencoder on the class for digit 3. The limited network capacity (˜1k weights) are repurposed to refine the reconstruction of class-specific samples. This way the prototypic autoencoder A is multiplexed to conditioned A_{l′} that perform best for x_{l′} with l=l′.

FIG. 12 illustrates improving on reconstruction by specializing to class samples: The top row illustrates a sample of class 3, i.e. its ground truth x₃ (left), the reconstruction A(x₃) of the prototypic A after stage 1 (center), and the reconstruction A₃ (x₃) after conditioning A on data {x₃} to become A₃ (right). The bottom row indicates: A(x₃)-x₃ (left), A₃(x₃)-x₃ (center), and A₃(x₃)-A(x₃) (right), respectively.

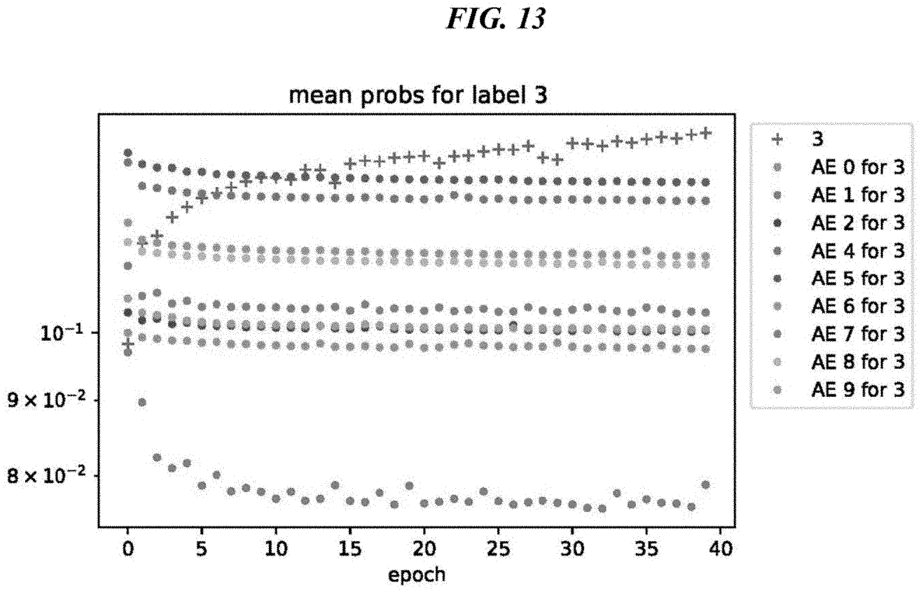

FIG. 13 illustrates an evolution of the class probability determined through the conditioning of autoencoders. Depicting label 1=3 as representative, it is presented the mean 1/N₃Σ^{x=x}^{ₗ₌₃}p′(l′=3|x) (symbol +) and means 1/N₃Σ^{x=x}^{ₗ₌₃}p′(l′≠3|x) (symbols .) for labeled data xₗ₌₃ with N₃=|{x:x=xₗ₌₃}|. While the odds from A₃ grows by directly conditioning on {x₃}, all others indirectly shrink by training on {x_{l≠3}}.

FIG. 13 indicates the evolution of the reconstruction for 1=3 in terms of probabilities p′₀(l′|xₗ₌₃). A clear separation by a rising p′₀(l′=l=3|xₗ₌₃) and all p′₀(l′≠l=3|xₗ₌₃) dropping for fixed class 1=3 develops over the course of multiple epochs. The trend is numerically observed to qualitatively repeat for 1 other than 3. It is the basis for the third and final stage where labels are grown.

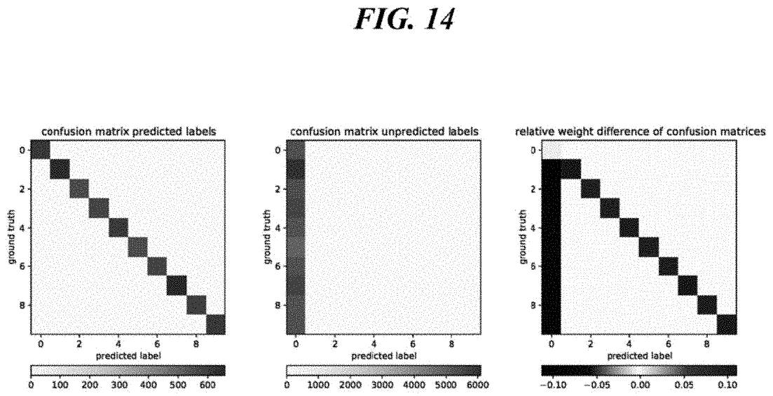

FIG. 14 illustrates a confusion matrix for initialized label probabilities p₀′ for labeled (C, blue) and unlabeled (C̅, green) data (from available ground truth). The matrix to the right is the difference of the ones to the left and in the center when normalized such that for both of its elements

$${{C}^{( - )}}_{ll ( \tilde{x} )} \to {{c}^{( - )}}_{ll ( \tilde{x} )}$$

it holds:

$$1 = {\sum }^{ij} {c}_{ij}^{( - )} .$$

A comprehensive picture is carved by the computation of the confusion matrix C with elements Cₗₗ₍ₓ_{ₗ}₎≥0 counting the number of data samples xₗ labeled as l(xₗ). In practice it is impossible to determine C for unlabeled data x̅. As mentioned earlier, for our experiments we simply hold out 90% of the labels in MNIST to form {x̅} keeping corresponding l̅ to evaluate C̅, but not entering any of the three training stages. Assigning a label l(\tilde{x}) from the probability distributions p′ₙ(l′|\tilde{x}) we employ:

lₙ(\tilde{x})=argmax_{l′}p′ₙ(l′|\tilde{x})

after n iterations.

For the initial distributions p₀′(l′|xₗ)=δ_{ll′} (labeled data) as well as p₀′(l′|x̅)=1/Nₜ=(unlabeled data), FIG. 7 presents the confusion matrices C (labeled data) and C (unlabeled data). Moreover, it is depicted the relative difference c−c̅ with normalized c˜C and C̅˜c̅ such that the sum of their elements adds to 1. Per convention the operation argmax_{l′} returns the first label l′ if there exist multiple pₙ′ equal in value. This is why all unlabeled data get mapped to label l′=0 in C̅.

Label Growing

The label growing stage kicks off by predicting for each data sample \tilde{x} (labeled and unlabeled) the label probability distribution p″₀ proportional to the inverse of the reconstruction losses given by the conditioned autoencoders A_{l′} from stage 2 of the training procedure. Our experiments uncovered that a loss [symbol] ᵢ [pₙ′, pₙ″] barely based on simultaneously minimizing the cross entropy between pₙ′ and pₙ″ as well as the entropy of pₙ″ significantly degrades the reconstruction loss: Enforcing a peaked probability distribution pₙ″, for each training sample 9 out of 10 autoencoders A_{l′=l} get encourages to not well reconstruct handwritten digits in order to increase the margin to the one autoencoder A_{l′=l} that needs to perform well.

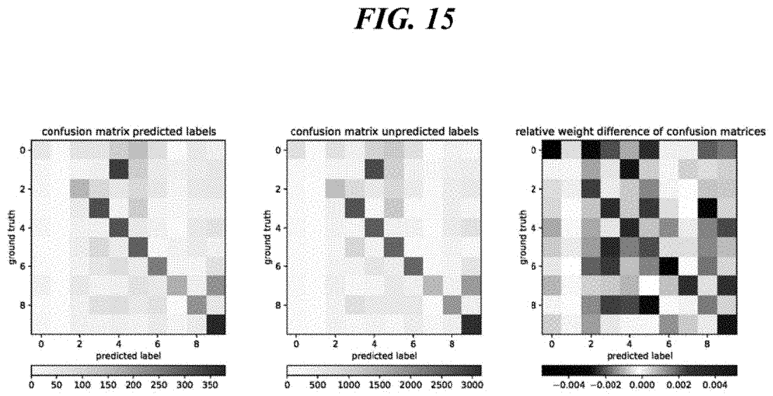

FIG. 15 illustrates confusion matrices as in FIG. 14, but after system initialization which conditions the autoencoders A_{l′} on labeled data x_{l=l′}.

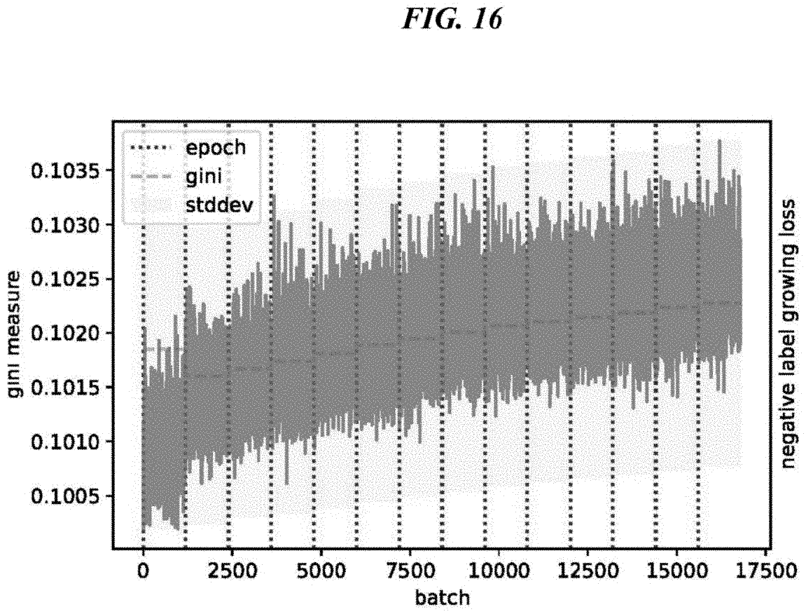

FIG. 16 illustrates an evolution of the (negative of the) training loss for the final, third stage growing labels. From epoch to epoch the purity measure [symbol] Gₙ^{a} [symbol] (gini) increases. However, its standard deviation (stddev) exceeds its range of increase over the course of the epochs trained. It is an aspect of further research to simultaneously shrink the noise of G^{α} while improving on its absolute value towards its optimum 1>>0.102.

Decay of Information from the Initialization Phase

Since the procedure is designed unsupervised where no label information l explicitly enters training stage 3, over the course of training, a small subset of the A_{l′} (typically one or two of them) will perform best in reconstruction on all data \tilde{x}. All others tend to optimize A_{l′}(\tilde{x}) to strongly deviate from all \tilde{x}. Therefore, for each training batch of (unlabeled) data from {\tilde{x}}, we added a second forward-backward pass of labeled data from {(xₗ, l)} through their respective A_{l′=l} to additively adjust the networks weight parameter gradients based on image reconstruction. This way, we counteract the natural decay of reconstruction for each A_{l′} when the ensemble of all autoencoders simultaneously tries to minimize the entropy of the predicted probability distribution pₙ″. FIG. 16 depicts how the purity measure Gₙ^{a} and the overall loss evolve to optimize the network weights over the course of 14 epochs.

Quantification of Improved Labeling

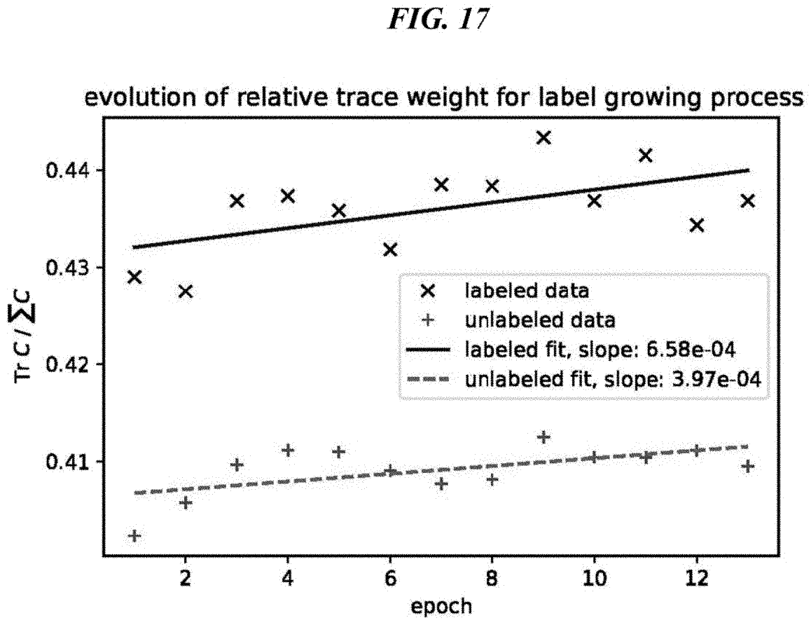

Nevertheless, as mentioned, while Gₙ^{a} needs to increase for n→∞, it is not guaranteed that the resulting prediction lₙ(\tilde{x}) converges towards the desired result. Hence, FIG. 17 monitors the quantity

$$\sum \text{?} C \text{?} / \sum \text{?} C \text{?} = TrC / \sum C$$

$$\text{?} \text{indicates text missing or illegible when filed}$$

while the A_{l′}s are trained.

A linear fit confirms that weight accumulates to the diagonal of the confusion matrix while training. However, further research needs to be invested in order to significantly increase the currently shallow slope.

FIG. 17 illustrates an evolution of the relative weight of the diagonal of the confusion matrices separately visualized for labeled (cf. C, symbols ×) and unlabeled (cf. C, symbols +) data. Note that we adjusted the label growing procedure such that in addition to an unsupervised increase of the label probability purity measure G^{α}, we preserve the reconstruction of the A_{l′} by adding the corresponding loss. Before updating the network weights after passing a batch of (unlabeled) data from {\tilde{x}}, batches of labeled data from {(xₗ, l)} is sent through the respective network A_{l′=l} in parallel. This way (e.g. in PyTorch), one more backward pass additively adjusts the gradient computed by the previous backward pass obtained by the batch of the (unlabeled) data.

What is claimed is:

1. A computer-implemented method for automatically labeling an amount of unlabeled data for training one or more classifiers of a machine learning system, the method comprising:
receiving a collection of unlabeled data;
receiving a collection of labeled data, each labeled data item in the collection being associated with a label in a set of labels;
associating a first probability distribution to each labeled data item in the collection of labeled data;
associating a second probability distribution to each unlabeled data item in the collection of unlabeled data; and
processing each unlabeled data item in the collection of unlabeled data, with an autoencoder architecture including one or more autoencoders, until a stop condition is detected by the autoencoder architecture, and in response associating a label to each processed unlabeled data item associated with a peaking probability distribution.

2. The computer implemented method of claim 1, further comprising:
associating by the autoencoder architecture a label in the set of labels to a processed unlabeled data item.

3. The computer implemented method of claim 1, wherein the first probability distribution including one probability value for each label in the set of labels, and the probability value associated with the label of the each labeled data item being set to a 1.0, and every other probability value in the probability distribution being set to 0.0.

4. The computer-implemented method of claim 1, wherein the processing, with the autoencoder architecture, each unlabeled data item, comprises:
encoding and compressing a particular data item received at an input of each autoencoder to a compressed data code version of the particular data item;
decoding and expanding the compressed data code version to a reconstructed version of the particular data item which is provided at an output of the each autoencoder;
comparing the output reconstructed version to the input particular data item; and
providing, based on the comparison, a loss of information value representing a loss of information from processing the input particular data item to the output reconstructed version, where the each autoencoder processes most accurately, with lowest loss of information, a particular data item that is likely a member of one of the one or more classified labeled sets of data that is associated with the each autoencoder and which is associated with one label in the set of labels.

5. The computer-implemented method of claim 1, further comprising:
determining, with the computer processing system, whether a highest probability in a peaking probability distribution associated with one processed unlabeled data item is above a high probability threshold value, and in response automatically adding to the set of classified labeled data associated with the label a new labeled data item which is the processed unlabeled data item that has the label automatically associated therewith.

6. The computer-implemented method of claim 5, wherein the high probability threshold value is at least 75% probability (0.75).

7. The computer-implemented method of claim 1, wherein the stop condition comprises:
monitoring, with the autoencoder architecture, a history of label probability purity values associated with the processed each unlabeled data item not increasing over one or more iterations of processing unlabeled data items by the autoencoder architecture.

8. The computer-implemented method of claim 7, wherein the stop condition comprises:
monitoring, with the autoencoder architecture, a history of label probability purity values associated with the processed each unlabeled data item not increasing over a threshold number of iterations of processing unlabeled data items by the autoencoder architecture.

9. The computer-implemented method of claim 1, wherein the stop condition comprises:
monitoring, with the autoencoder architecture, a history of label probability purity values associated with the processed each unlabeled data item decreasing over one or more iterations of processing unlabeled data items by the autoencoder architecture.

10. The computer-implemented method of claim 9, wherein the stop condition comprises:
monitoring, with the autoencoder architecture, a history of label probability purity values associated with the processed each unlabeled data item decreasing over a threshold number of iterations of processing unlabeled data items by the autoencoder architecture.

11. The computer-implemented method of claim 1, wherein the stop condition comprises:
monitoring, with the autoencoder architecture, a history of label probability purity values associated with the processed each unlabeled data item not increasing over one or more iterations of processing unlabeled data items by the autoencoder architecture.

12. The computer-implemented method of claim 1, wherein:
in response to the autoencoder architecture detecting the stop condition, the autoencoder architecture automatically associating a label in the set of labels to the processed unlabeled data item, based on the label being associated with a highest probability value in a peaking probability distribution associated with the processed unlabeled data item and the highest probability exceeding a high probability threshold value.

13. The computer-implemented method of claim 12, wherein the high probability threshold value is at least 90% probability (0.9).

14. A computing processing system, comprising:
a server;
an autoencoder architecture including one or more autoencoders;
persistent memory;
a network interface device for communicating with one or more communication networks; and
at least one processor, communicatively coupled with the server, the persistent memory, the autoencoder architecture, and the network interface device, the at least one processor, responsive to executing computer instructions, for performing operations comprising:
receiving at a data input device of the computing processing system a collection of unlabeled data, each unlabeled data item in the collection having unknown membership in any of one or more classified labeled sets of data associated with respective one or more labels in a set of labels which are associated with respective one or more classifiers in a machine learning system, each classified labeled set of data being used to train a respective each classifier associated with the each classified labeled set of data, and wherein each autoencoder in the one or more autoencoders is associated with a respective one label in the set of labels;
receiving at a data input device of the computing processing system a small collection of labeled data, each labeled data item in the collection being accurately assigned a particular label, with a high level of confidence, from the one or more labels in the set of labels, the accurately assigned particular label indicating that the labeled data item is a member of one of the one or more classified labeled sets of data;
associating a probability distribution to each labeled data item in the collection of labeled data, the probability distribution including one probability associated with each label in the set of labels, where a probability in the probability distribution that is associated with the accurately assigned particular label being set to 1.0, and where every other probability in the probability distribution associated with the each labeled data item being set to 0.0;
associating a probability distribution to each unlabeled data item in the collection of unlabeled data, the probability distribution including one probability associated with each label in the set of labels, where each probability in the probability distribution associated with the each unlabeled data item being set to the number 1.0 divided by the total number of labels in the set of labels;
iteratively processing, with the autoencoder architecture, each unlabeled data item in the collection of unlabeled data by:
receiving a same unlabeled data item at an input of each autoencoder in the one or more autoencoders, where each autoencoder has been trained and has learned to process each particular data item received at an input of the each autoencoder, and where each autoencoder processes most accurately, with a lowest loss of information, a particular data item that is likely associated with a label associated with the each autoencoder, while processing less accurately, with a higher loss of information, a particular data item that is likely not associated with a label associated with the each autoencoder;
the autoencoder architecture, based on the loss of information determined by each autoencoder in the one or more autoencoders processing the each individual unlabeled data item, predicting a probability distribution for the each individual unlabeled data item; and
the autoencoder architecture updates a probability distribution already associated with the each individual unlabeled data item with the predicted probability distribution, based on a determination that the predicted probability distribution is more peaking than the probability distribution already associated with the each individual unlabeled data item; and
repeating the iteratively processing, with the autoencoder architecture, of a next unlabeled data item in the collection of unlabeled data, until a stop condition is detected by the autoencoder architecture; and
in response to the autoencoder architecture detecting a stop condition, the autoencoder architecture automatically associating a label in the set of labels to at least one processed unlabeled data item, based on the label being associated with a highest probability in a peaking probability distribution associated with the at least one processed unlabeled data item in the collection of unlabeled data.

15. The computing processing system of claim 14, wherein the operations comprising:
determining, with the computing processing system, whether a highest probability in the peaking probability distribution associated with the at least one processed unlabeled data item is above a high probability threshold value, and in response automatically adding to the set of classified labeled data associated with the label a new labeled data item which is the processed unlabeled data item that has the label automatically associated therewith.

16. The computing processing system of claim 15, wherein the autoencoder architecture comprises at least one of:
a cloud computing network architecture including at least one computation cloud node and at least one storage cloud node; and/or
a high performance computing network architecture.

17. The computing processing system of claim 14, wherein the stop condition comprises:
monitoring, with the autoencoder architecture, a history of label probability purity values associated with the at least one processed unlabeled data item not increasing over one or more iterations of processing unlabeled data items by the autoencoder architecture.

18. A computer program product for automatically labeling an amount of unlabeled data for training one or more classifiers of a machine learning system, the computer program product comprising:
a non-transitory computer readable storage medium readable by a processing device and storing program instructions for execution by the processing device, said program instructions comprising:
receiving a collection of unlabeled data;
receiving a collection of labeled data, each labeled data item in the collection being associated with a label in a set of labels;
associating a first probability distribution to each labeled data item in the collection of labeled data;
associating a second probability distribution to each unlabeled data item in the collection of unlabeled data; and
processing each unlabeled data item in the collection of unlabeled data, with an autoencoder architecture including one or more autoencoders, until a stop condition is detected by the autoencoder architecture, and in response associating a label to each processed unlabeled data item associated with a peaking probability distribution.

19. The computer program product of claim 18, further comprising:
associating by the autoencoder architecture a label in the set of labels to a processed unlabeled data item.

20. The computer program product of claim 18, wherein:
in response to the autoencoder architecture detecting the stop condition, the autoencoder architecture automatically associating a label in the set of labels to the processed unlabeled data item, based on the label being associated with a highest probability value in a peaking probability distribution associated with the processed unlabeled data item and the highest probability exceeding a high probability threshold value.
